(19) United States
(12) Patent Application Publication
(10) Pub. No.: US 2007/0103786 A1
(43) Pub. Date: May 10, 2007

(54) Optical film, anti-reflection film, polarizing plate and image display device

(75) Inventor: Yuuzou Muramatsu, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/592,267

(22) Filed: Nov. 3, 2006

(30) Foreign Application Priority Data
Nov. 7, 2005 (JP) P.2005-322339

(51) Int. Cl. G02B 5/02

(52) U.S. Cl. 359/599; 359/483

(57) ABSTRACT

An optical film, which comprises: a transparent support; and a light-diffusing layer containing: at least one kind of resin particles having a particle size of from 5 μm to 20 μm; and a binder matrix, wherein the resin particles have a compressive strength of from 2 to 10 kgf/mm²; an anti-reflection film; a polarizing plate; and an image display device using the optical film.

### BACKGROUND OF THE INVENTION

1. Field of the Invention

The present invention relates to an optical film, and an anti-reflection film, a polarizing plate and image display device using the optical film.

2. Description of the Related Art

In recent years, accompanied by the progress of enlarged-size screen of a liquid crystal display (LCD), liquid crystal display devices having an optical film, e.g., an anti-reflection film, are increasing in number.

The anti-reflection film is disposed on the surface of various displays such as a liquid crystal display device (LCD), a plasma display panel (PDP), an electro-luminescence display (ELD) and a cathode ray tube display (CRT) for preventing reduction in contrast due to reflection of external light or images. As one means for imparting anti-reflection properties to an anti-reflection film, a light-diffusing layer is provided. This layer usually contains particles which serve to reduce reflection of images by imparting unevenness to the surface or by scattering reflected light at the surface of the particles.

The anti-reflection film is required to have a high film hardness in addition to the anti-reflection ability. The high film hardness is required so that the anti-reflection film to be applied to the outermost surface of a display does not suffer deterioration of viewability due to scratches or pushed marks.

As a highly hard film, there have been known a high refractive index film having an outer layer reactive with a highly cross-linked core portion (JP-A-7-92306), a film containing resin particles whose volume swelling ratio is adjusted to a level lower than a certain value by incorporating a cross-linking agent (JP-A-2004-226832), and a film wherein the thickness of a hard coat layer is adjusted to a certain range by incorporating therein inorganic fine particles (JP-A-2000-112379). However, in order to improve high hardness of the film, more adequate materials have been required.

### SUMMARY OF THE INVENTION

An object of the invention is to stably provide an optical film having excellent optical properties and a high surface hardness.

Another object of the invention is to provide an anti-reflection film, a polarizing plate and an image display device using the optical film.

The above-described problems have been solved by the optical film, polarizing plate and image display device having the following constitution.

(1) An optical film, which comprises:

a transparent support; and

a light-diffusing layer containing: at least one kind of resin particles having a particle size of from 5 μm to 20 μm; and a binder matrix,

wherein the resin particles have a compressive strength of from 2 to 10 kgf/mm².

(2) The optical film as described in (1) above,

wherein the resin particles show a swelling ratio of 20% by volume or less when dipped in a dispersing solvent.

(3) The optical film as described in (1) or (2) above,

wherein the light-diffusing layer has a thickness of from 10 μm to 20 μm.

(4) The optical film as described in any of (1) to (3) above,

wherein the resin particles are cross-linked with a cross-linking monomer having two or more functional groups, and

a content of the cross-linking monomer is 15% by mass or more based on a mass of the total monomers for forming the resin particles.

(5) The optical film as described in any of (1) to (4) above,

wherein a difference in refractive index between the resin particles and the binder matrix is from 0 to 0.10.

(6) The optical film as described in any of (1) to (5) above,

wherein the resin particles are resin particles obtained by polymerizing a (meth)acrylate monomer.

(7) The optical film as described in any of (1) to (6) above,

wherein the light-diffusing layer contains as a binder an epoxy resin having two or more epoxy groups per molecule in a content of from 20 to 100% by mass based on a mass of the total binders.

(8) An anti-reflection film,

wherein the anti-reflection film is an optical film as described in any of (1) to (7) above.

(9) A polarizing plate, which comprises:

a polarizing film; and

at least two protective films for the polarizing film,

wherein at least one of the at least two protective films is an anti-reflection film as described in (8) above.

(10) An image display device, which comprises an optical film as described in any of (1) to (7) above, an anti-reflection film as described in (8) above or a polarizing plate as described in (9) above disposed on an image display surface.

### DETAILED DESCRIPTION OF THE INVENTION

In this specification, the term “from (numeral I) to (numeral II)” means “equal to (numeral I) or more to equal to (numeral II) or less”. Also, the term “(meth)acryloyl” as used herein means “at least either of acryloyl and methacryloyl”. The same applies to “(meth)acrylate” and “(meth)acrylic acid”.

The invention will be described in more detail below.

The optical film of the invention comprises a transparent support having provided thereon a light-diffusing layer containing at least one kind of resin particles of 5 μm to 20 μm in particle size and a binder matrix, with the resin particles having a compressive strength of from 2 to 10 kgf/mm².

Light-diffusing Layer

The light-diffusing layer in accordance with the invention includes all layers that contain resin particles and that exert influences on optical performance. For example, it includes a high refractive index layer, middle refractive index layer, low refractive index layer, anti-glare layer, anti-glare and anti-reflective layer, middle layer and a hard coat layer containing resin particles

The light-diffusing layer is formed by a main binder (a light-transmittable polymer formed by curing a monomer and/or a polymer through heat and/or ionization radiation or the like), light-transmittable particles, an additive for increasing strength of film and, as needed, inorganic fine particles for adjusting refractive index and a high molecular compound for controlling anti-glare properties and coating solution properties.

The thickness of the light-diffusing layer is usually from about 3 μm to about 30 μm, preferably from 10 μm to 20 μm, more preferably from 12 μm to 17 μm. When the thickness is within the above-described range, there result defects with respect to curl, haze value and production cost and, in addition, adjustment of anti-glare properties and light-diffusing effects are easy.

(Main Binder)

A binder for forming a main matrix which forms the light-diffusing layer (hereinafter also merely referred to as “binder”) is not specifically limited, but a light-transmittable polymer formed by curing a monomer and/or a polymer through heat and/or ionization radiation or the like is exemplified, and a light-transmittable polymer, which has a saturated hydrocarbon chain or a polyether chain as a main chain after being cured with heat and/or ionization radiation or the like, is preferred. It is also preferred for the cured main binder polymer to have a cross-linked structure.

As a binder polymer having a saturated hydrocarbon chain as a main chain after being cured, ethylenically unsaturated monomers and polymers thereof (the first group compounds) are preferred and, as a polymer having a polyether chain as a main chain, epoxy monomers and polymers formed by ring opening of the monomers (the second group compounds) are preferred. Further, polymers of a mixture of these monomers are preferred. These compounds will be described below.

(First Group Compounds)

As the binder polymer having a saturated hydrocarbon chain as a main chain and having a cross-linked structure, (co)polymers of a monomer having two or more ethylenically unsaturated groups are preferred.

In order to obtain a high refractive index, it is preferred to incorporate in the monomer structure at least one member selected from among halogen atoms other than fluorine atom, a sulfur atom, a phosphorus atom and a nitrogen atom.

Monomer having two or more ethylenically unsaturated groups to be used in the binder polymer for forming the light-diffusing layer include esters between a polyhydric alcohol and (meth)acrylic acid {e.g., ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth}acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cycohexane tetramethacrylate, polyurethane polyacrylate and polyester polyacrylate}, vinylbenzene and its derivatives (e.g., 1,4-divinylbenzene, 2-acryloylethyl 4-vinylbenzoate and 1,4-divinylcyclohexanone), vinylsulfones (e.g., divinylsulfone), and (meth)acrylamides (e.g., methylenebisacrylamide).

Futher, there can be illustrated resins having two or more ethylenically unsaturated groups, such as a polyester resin having a comparatively low molecular mass, a polyether resin, an acrylic resin, an epoxy resin, a urethane resin, an alkyd resin, a spiroacetal resin, a polybutadiene resin, a polythiol polyene resin, oligomers or prepolymers of a multi-functional compound such as polyhydric alcohol. These monomers may be used in combination of two or more thereof, and the resin having two or more ethylenically unsaturated groups is incorporated in a content of preferably from 10 to 70% based on the total mass of the binder.

Polymerization of the monomers having ethylenically unsaturated groups can be performed by irradiating with ionizing radiation or by heating in the presence of a photo radical polymerization initiator or a thermal radical polymerization initiator. Therefore, the light-diffusing layer is formed by preparing a coating solution containing the monomer having ethylenically unsaturated groups, a photo radical polymerization initiator or a thermal radical polymerization initiator, resin particles and, as needed, an inorganic filler, a coating aid and other additives, and at least two kinds of organic solvents, coating the coating solution on a transparent support, and conducting polymerization reaction by irradiating with ionizing radiation or by heating to cure. It is also preferred to conduct both curing by irradiating with ionizing radiation and thermal curing in combination. As the photo and thermal polymerization initiators, commercially available compounds can be utilized, which are described in Saishin UV Koka Gijutsu.(New UV Curing Technology), p.159 (published by Kazuo Takabo; publishing company: Kabusiki Kaisha Gijutsu Joho Kyokai; 1991) and a catalogue of Ciba Specialty Chemicals.

(Second Group Compounds)

In order to reduce curing shrinkage of the cured film, it is preferred to use epoxy compounds to be described hereinafter. As the monomers having epoxy groups, monomers having two or more epoxy groups per molecule are preferred. Examples thereof include epoxy monomers described in JP-A-2004-264563, JP-A-2004-264564, JP-A-2005-37737, JP-A-2005-37738, JP-A-2005-140862, JP-A-2005-140862, JP-A-2005-140863 and JP-A-2002-322430.

In view of reduction of curing shrinkage, the content of the monomers having epoxy groups is preferably from 20 to 100% by mass, more preferably from 35 to 100% by mass, still more preferably from 50 to 100% by mass, based on the mass of the total binder constituting the layer. (In this specification, mass ratio is equal to weight ratio.)

As the photo acid generator for generating cation by the action of light to be used to polymerize the epoxy monomers and compounds, there are illustrated ionic compounds such as triarylsulfonium salts and diaryliodonium salts, and nonionic compounds such as nitrobenzyl sulfonate, and various known photo acid generators such as those which are described in Imejinguyo Yuki Zairyo (Organic materials for imaging), compiled by Yuki Erekutoronikusu Zairyo Kenkyukai and published by Bunsin Shuppansha in 1997. Of these, sulfonium salts or iodonium salts are particularly preferred, with the counter ion being preferably PF₆⁻, SbF₆⁻, AsF₆⁻ and B(C₆F₅)₄⁻.

These polymerization initiators are used in an amount ranging from 0.1 to 15 parts by mass, more preferably from 1 to 10 parts by mass, per 100 parts by mass of the multi-functional monomers.

It is also preferred to use the first group compound and the second group compound in combination with the high molecular compound to be described below.

(High Molecular Compounds)

The optically functional layer (a high refractive index layer, a middle refractive index layer, a low refractive index layer, an anti-glare layer, an anti-glare and anti-reflective layer, a middle layer and a hard coat layer and the like) in accordance with the invention may contain a high molecular compound. The high molecular compound already forms a polymer at the point of being added to the coating composition and is incorporated mainly for the purpose of adjusting the viscosity of the coating composition which relates to dispersion stability (coagulating properties) of the resin particles or for controlling polarity of a solid product in the drying step to thereby change coagulating behavior of the resin particles or reduce drying unevenness in the drying process.

As such high molecular compound, there can preferably be used, for example, cellulose esters (e.g., cellulose triacetate, cellulose diacetate, cellulose propionate, cellulose acetate propionate, cellulose acetate butyrate and cellulose nitrate), urethane acrylates, polyester acrylates, (meth)acrylates (e.g., methyl methacrylate/methyl (meth)acrylate copolymer, methyl methacrylate/ethyl (meth)acrylate copolymer, methyl methacrylate/butyl (meth)acylate copolymer, methyl methacrylate/styrene copolymer, methyl methacrylate/(meth)acrylic acid copolymer and polymethyl methacrylate) and resins (e.g., polystyrene).

From the standpoint of developing the effect of increasing viscosity of the coating composition and maintaining film strength of the high molecular compound-containing layer, the high molecular compound is incorporated in a content of preferably from 3% by mass to 40% by mass, more preferably from 5% by mass to 30% by mass, still more preferably from 8% by mass to 25% by mass, based on the mass of the whole binders contained in the layer containing the high molecular compound. In case when the content is less than the above-described level, there results insufficient effect of increasing the viscosity of the coating composition whereas, when more than the above-described level, there results deteriorated film strength of the high molecular compound-containing layer.

The mass-average molecular mass of the high molecu s lar compound is preferably from 3,000 to 400,000, more preferably from 5,000 to 300,000, still more preferably from 5,000 to 200,000. When the molecular mass is in the above-described range, a sufficient effect of increasing viscosity of the coating composition can be obtained, with a dissolution being completed in a short time leaving a less amount of insolubles.

The optically functional layer is preferably formed by conducting, after coating the coating solution on a support, irradiation with light or electron beams or heating treatment to thereby cause cross-linking or polymerization reaction. In the case of conducting irradiation with UV rays, UV rays emitted from a light source such as a super-high pressure mercury lamp, a high pressure mercury lamp, a low pressure mercury lamp, a carbon arc, a xenon arc or a metal halide lamp can be utilized.

Curing with UV rays is conducted at an oxygen concentration of preferably 4% by volume or less, more preferably 2% by volume or less, most preferably 0.5% by volume or less, under purging with nitrogen.

Resin Particles

Resin particles of from 5 μm to 20 μm, preferably from 6 μm to 15 μm, more preferably from 7 μm to 12 μm, in average particle size are incorporated in the light-diffusing layer. The resin particles are used for the purpose of, for example, enhancing film strength, scattering external light reflected at the display surface to weaken the reflected light, and enlarging the viewing angle of a liquid crystal display device (particularly viewing angle in the downward direction) to thereby difficultly cause reduction of contrast, black-white reversal or change in hue even when the viewing angle in the observation direction is changed. When the average particle size is within the above-described range, there can be obtained anti-glare effect with no coarse appearance.

The compression strength of the resin particles in accordance with the invention is preferably from 2 kgf/mm² to 10 kgf/mm² (19.6 N/mm² to 98.1 N/mm²), more preferably from 4 kgf/mm² to 9 kgf/mm² (39.2 N/mm² to 88.3 N/mm²), still more preferably from 5 kgf/mm² to 8 kgf/mm² (49.0 N/mm² to 78.5 N/mm ²). When the compression strength is within the above-described range, the resin particles can contribute to increase in the film hardness with scarcely suffering particle destruction due to increase in fragility.

In the invention, the term “compression strength” means compression strength when the particle size is deformed 10%. The compression strength when the particle size is deformed 10% is particle compression strength (S10 strength) and is a value obtained by introducing a load obtained when the particle size is deformed 10% and a particle size before compression into the following formula:
S10Strength(kgf/mm²)=2.8×load(kgf)/{(π×particle size(mm)×particle size(mm))

The measuring method of compression strength is not specifically limited as long as a measuring method is capable of obtaining the above parameters. For example, compression strength can be obtained by conducting a compression test using a micro-compression testing machine MCT-W201 manufactured by Shimazu Mgf. Works in which a constant load speed is applied to a single resin particle.

In the invention, the swelling ratio is determined by dispersing the resin particles in toluene in a concentration of 30% by mass, measuring a particle size (r1) within 3 hours after completion of the dispersion and a particle size (r2) at the time when an increase in particle size is stopped after the dispersion is allowed to stand at room temperature (25° C.), and introducing r1 and r2 into the following formula:
Swelling ratio(% by volume)={(r2/r1)³−1}×100

The swelling ratio is preferably 20% by volume or less, more preferably 15% by volume or less, still more preferably 10% by volume or less.

The difference in refractive index between the resin particles and the binder of light-transmittable resin is preferably from 0 to 0.1, particularly preferably from 0 to 0.08, in view of preventing white turbidity or, with some resins, obtaining light-diffusing effect.

With respect to the addition amount of the resin particles for the transmittable resin, a preferred range is determined from the same standpoint. The content of the resin particles in the layer is preferably from 3% by mass to 40% by mass, particularly preferably from 5% by mass to 25% by mass, based on the mass of the whole solid components in the optically functional layer.

As to the coated amount of the resin particles, they are incorporated in the optically functional layer in an amount of preferably from 10 mg/m² to 10000 mg/m², more preferably from 50 mg/m² to 4,000 mg/m², most preferably from 100 mg/m² to 1,500 mg/m², in terms of the particle amount in the formed optically functional layer.

Regarding relation between the particle size of the resin particles and the film thickness of the layer containing them, the average particle size of the resin particles is preferably from 20% to 110%, more preferably from 30% to 100%, most preferably from 35% to 80%, of the film thickness of the layer containing them. When the average particle size is within this range, an image with excellent blackness is obtained with excellent anti-glare properties.

The particle size distribution of the particles is measured according to the Couler counter method, and the obtained distribution is converted to a particle number distribution. The average particle size is calculated from the thus-obtained particle distribution.

As the resin particles, two or more different kinds of resin particles may be used in combination thereof. In the case of using two or more kinds of resin particles, the difference in refractive index between the highest refractive index resin particles and the lowest refractive index resin particles is preferably from 0.01 to 0.10, particularly preferably from 0.02 to 0.07, in order to effectively obtain the effect of controlling refractive index by mixing the two or more kinds of particles. It is also possible to impart anti-glare properties by resin particles having a larger particle size and other optical properties by resin particles having a smaller particle size. For example, unevenness of luminance, called dazzling, due to unevenness on the film surface (contributing to anti-glare properties), which is particularly problematical with respect to an anti-reflection film for a highly fine display of 133 ppi or more, can be reduced.

The cross-linking ratio of the resin particles is preferably as low as possible within the range where the resins can maintain dissolution resistance. The cross-linking ratio of the resin particles in accordance with the invention can be expressed in terms of the content of a cross-linking monomer based on the whole monomers participating in formation of the particles. The content of the cross-linking monomer is equal to or more than 15% by mass, preferably from 17% by mass to 50% by mass, more preferably from 20% by mass to 40% by mass, for improving film hardness.

Also, the gel fraction of the resin particles in accordance with the invention is preferably from 80% by mass to 99% by mass for improving film hardness. The gel fraction can be determined according to the following method.

A definite amount of particle powder is heated and stirred in methyl ethyl ketone for a predetermined period of time, the particle is separated by filtration, and the filtrate is concentrated to dryness to determine the mass of the residue. The ratio of the mass of solid components which have not been dissolved into methyl ethyl ketone but remain to the original mass was calculated from the above-found mass of the residue.

As the cross-linking monomers constituting the resin particles in accordance with the invention, there are specifically illustrated aromatic monomers such as divinylbenzene, trivinylbenzene, divinyltoluene, divinylxylene, ethyldivinylbenzene, divinylnaphthalene, divinylalkylbenzenes, divinylphenanthlene, divinylbiphenyl, divinyldiphenylmethane, divinylbenzyl, divinylphenyl ether and divinyldiphenylsulfide; oxygen-containing monomers such as divinylfuran; sulfur-containing monomers such as divinylsulfide and divinylsulfon; aliphatic monomers such as butadiene, isoprene and pentadiene; and ester compounds such as ethylene glycol di(meth)acrylate, diethylene glycol di(meth)acrylate, triethylene glycol di(meth)acrylate, polyethylene glycol di(meth)acrylate, 1,3-butanediol di(meth)acrylate, 1,4-butanediol di(meth)acrylate, 1,6-hexanediol di(meth)acrylate, octanediol di(meth)acrylate, decanediol di(meth)acrylate, trimethylolpropane di(meth)acrylate, trimethylolpropane tri(meth)acrylate, pentaerythritol di(meth)acrylate, pentaerythritol di(meth)acrylate, pentaerythritol tri(meth)acrylate, pentaerythritol tetra(meth)acrylate, dipentaerythritol di(meth)acrylate, dipentaerythritol tri(meth)acrylate, dipentaerythritol tetra(meth)acrylate, N,N′-methylenebis(meth)acrylamide, triallyl isocyanurate, triallylamine, tetraallyloxyethane and ester compounds between a polyhydric alcohol such as hydroquinone, catechol, resorcinol or sorbitol and acrylic or methacrylic acid. These may be used independently or in combination of two or more thereof.

Of these, ethylene glycol di(meth)acrylate, trimethylolpropane tri(meth)acrylate, pentaerythritol tri(meth)acrylate, pentaerythritol tetra(meth)acrylate, divinylbenzene, trivinylbenzene and divinyinaphthalene are preferred.

Preferred specific examples of the resin particles in accordance with the invention include resin particles such as cross-linked polymethyl methacrylate particles, cross-linked methyl methacrylate-styrene copolymer particles, cross-linked polystyrene particles, cross-linked methyl methacrylate-methyl acrylate copolymer particles and cross-linked acrylate-styrene copolymer particles. Of these, cross-linked styrene particles, cross-linked polymethyl methacrylate particles and cross-linked methyl methacrylate-styrene copolymer particles are preferred.

As to the production process, the resin particles in accordance with the invention may be produced by any of processes such as a suspension polymerization process, an emulsion polymerization process, a soap-free emulsion process, a dispersion polymerization process and a seed polymerization process. Regarding these production processes, reference may be made to, for example, descriptions in Kobunshi Kosei no Jikkenho (Experimental Techniques for Polymer Synthesis) written by Takayuki Otsu & Masaetsu Kinoshita and published by Kagaku Dojinsha, p. 130 and pp. 146 to 147, processes described in Gosei Kobunshi (Synthetic High Polymers), vol. 1, pp. 246 to 290, ibid., vol. 3, pp. 1 to 108, and processes described in Japanese Patent Nos. 2,543,503, 3,508,304, 2,746,275, 3,521,560, 3,580,320, JP-A-10-1561, JP-A-7-2908, JP-A-5-297506 and JP-A-2002-145919.

For example, with respect to emulsion polymerization or suspension polymerization, a process of polymerizing a monomer atomized in an aqueous medium is illustrated as one example. Examples of a surfactant for stabilizing dispersion include anionic surfactants such as dodecylbenzenesulfonate, dodecyl sulfate, lauryl sulfate and dialkylsulfosuccinate; and nonionic surfactants such as polyoxyethylene nonylphenyl ether and polyethylene glycol monostearate. Further, as a dispersion-stabilizing agent, there can be illustrated polymers or oligomers, such as polyvinyl alcohol, sodium polyacrylate, hydrolyzate of styrene-maleic anhydride copolymer, sodium alginate and water-soluble cellulose derivative. Also, in a process of conducting addition polymerization reaction to be initiated by an oil-soluble polymerization initiator in the presence of an inorganic salt and/or a dispersion-stabilizing agent using water as a dispersing medium, sodium chloride, potassium chloride, calcium chloride or magnesium sulfate may be used as a water-soluble salt. As the polymerization initiator, there can be illustrated azobis compounds (e.g., azobisisobutyronitrile and azobis[cyclohexane-1-carbonitrile]) and peroxides (e.g., benzoyl peroxide and t-butyl peroxide).

Further, a so-called multi-step polymerization process is also preferred wherein fine polymer particles previously prepared are impregnated with a monomer to make the particles larger in size.

As to shape of the resin particles, either of true-sphere particles and amorphous particles may be used. As to particle size distribution, mono-disperse particles are preferred in view of controllability of haze value and diffusing properties and uniformity of the coated surface. For example, when particles having a particle size larger than the average particle size by 20% are defined as coarse particles, the proportion of the coarse particles is preferably 1% or less, more preferably 0.01% or less, based on the population of the total particles. Particles having such particle size distribution can be obtained by classification after ordinary synthesis reaction, and particles having a more preferred particle size distribution can be obtained by increasing the number of classification or strengthening the classification degree.

In order to raise the refractive index of the optically functional layer, it is also preferred to incorporate, in addition to the above-described particles, a fine inorganic filler comprising at least one oxide of a metal selected from among titanium, zirconium, aluminum, indium, zinc, tin and antimony and having an average primary particle size of 0.2 μm or less, preferably 0.1 μm or less, still more preferably 0.06 μm or less in the optically functional layer.

On the contrary, with an optically functional layer using resin particles having a high refractive index, it is also preferred to reduce the refractive index of the binder in order to enlarge the difference in refractive index between the resin and the particles. For such purpose, silica fine particles, hollow silica fine particles, etc. can be used. A preferred particle size of the particles is the same as that of the aforesaid fine inorganic filler particles having a high refractive index.

Specific examples of the fine inorganic filler to be used in the optically functional layer include TiO₂, ZrO₂, Al₂O₃, In₂O₃, ZnO, SnO₂, Sb₂O₃, ITO and SiO₂. Of these, TiO₂ and ZrO₂ are particularly preferred in view of raising refractive index. The surface of the inorganic filler may preferably be subjected to surface treatment such as silane coupling treatment or titanium coupling treatment. A surface treating agent which can provide the surface of the filler with a functional group capable of reacting with the binder species is preferably used.

The addition amount of the fine inorganic filler is preferably from 10 to 90%, more preferably from 20 to 80%, particularly preferably from 30 to 75%, based on the total mass of the layer containing it.

Additionally, the fine inorganic filler has a particle size enough shorter than the wavelength of light not to cause scattering, and hence a dispersion of the filler in a binder polymer has optically uniform properties.

(Low Refractive Index Layer)

The low refractive index layer contains a fluorine-containing compound. It is particularly preferred to constitute a low refractive index layer containing the fluorine-containing compound as a major component. The low refractive index layer containing the fluorine-containing compound as a major component is usually provided as the outermost layer of an anti-reflection film and also functions as a stain-proof layer. The term “containing the fluorine-containing compound as a major component” as used herein means that the mass ratio of the fluorine-containing compound is the largest among those of the constituents contained in the low refractive index layer. The content of the fluorine-containing compound is preferably 50% by mass or more, more preferably 60% by mass or more, based on the total mass of the low refractive index layer.

The fluorine-containing compound of the low refractive index layer is preferably formed by cross-linking or polymerization reaction of a fluorine-containing compound having a cross-linkable group or a polymerizable group caused by heating or irradiation with ionization radiation to cure. The fluorine-containing compound may be a commercially available one, and is not particularly limited. A preferred formulation will be described below.

(Fluorine-Containing Compound)

The fluorine-containing compound to be incorporated in the low refractive index layer has a refractive index of preferably from 1.35 to 1.50, more preferably from 1.36 to 1.47, still more preferably from 1.38 to 1.45.

Examples of the fluorine-containing compound include fluorine-containing polymers, fluorine-containing silane compounds, fluorine-containing surfactants and fluorine-containing ethers.

As the fluorine-containing polymers, there are illustrated those which are synthesized by cross-linking or polymerization reaction of an ethylenically unsaturated monomer containing a fluorine atom. Examples of the ethylenically unsaturated monomer containing a fluorine atom include fluoroolefins (e.g., fluoroethylene, vinylidene fluoride, tetrafluoroethylene, hexafluoropropylene and perfluoro-2,2-dimethyl-1,3-dioxol), fluorinated vinyl ether and esters between a fluorine-substituted alcohol and acrylic acid or methacrylic acid.

As the fluorine-containing polymer, copolymers comprising a fluorine atom-containing repeating structural unit and a fluorine atom-free repeating structural unit can also be used.

Such copolymer can be obtained by polymerization reaction between a fluorine atom-containing, ethylenically unsaturated monomer and a fluorine atom-free ethylenically unsaturated monomer.

As the fluorine atom-free ethylenically unsaturated monomer, there are illustrated olefins, acrylates, methacrylates, styrene and the derivatives thereof, vinyl ethers, vinyl esters, acrylamides (e.g., N-cyclohexylacrylamide), methacrylamides and acrylonitrile.

As the fluorine-containing silane compound, there are illustrated silane compounds having a perfluoroalkyl group.

The fluorine-containing surfactant is a compound wherein hydrogen atoms of the hydrocarbon constituting a hydrophobic moiety are partly or wholly substituted by fluorine atoms, with the hydrophilic moiety thereof being any of anionic, cationic, nonionic and amphoteric ones.

The fluorine-containing ether is a compound which is generally used as a lubricant. Examples of the fluorine-containing ether include perfluoropolyethers.

As the fluorine-containing compound of the low refractive index layer, fluorine-containing polymers into which a cross-linked or polymerized structure is introduced are particularly preferred. The fluorine-containing polymers into which a cross-linked or polymerized structure is introduced can be obtained by cross-linking or polymerizing a fluorine-containing compound having a cross-linkable or polymerizable functional group.

The fluorine-containing compound having a cross-linkable or polymerizable functional group can be obtained by introducing a cross-linkable or polymerizable functional group into a fluorine-containing compound not having the cross-linkable or polymerizable group as a side chain. Examples of the cross-linkable or polymerizable functional group include (meth)acryloyl, isocyanato, epoxy, aziridine, oxazoline, aldehydo, carbonyl, hydrazine, carboxyl, methylol and active methylene. Further, groups such as hydroxyl, amino and sulfu may additionally be contained. Commercially available compounds may be used as such compound.

The fluorine-containing compound of the low refractive index layer preferably contains, as a major component, a copolymer comprising a repeating unit derived from the fluorine-containing vinyl monomer and a repeating unit having a (meth)acryloyl group in the side chain. The content of the component derived from the copolymer is preferably 50% by mass or more, more preferably 70% by mass or more, particularly preferably 90% by mass or more, based on the total mass of the outermost layer. The copolymer to be preferably used in the low refractive index layer will be described below.

As the fluorine-containing vinyl monomer, there are illustrated fluoroolefins (e.g., fluoroethylene, vinylidene fluoride, tetrafluoroethylene, hexafluoroethylene and hexafluoropropylene), partially or completely fluorinated alkyl ester derivatives of (meth)acrylic acid (e.g., Viscoat 6FM (trade name; manufactured by Osaka Organic Chemical Industry Ltd.) and M-2020 (trade name; manufactured by Daikin Industries), and completely or partially fluorinated vinyl ethers, with perfluoroolefins being preferred. Hexafluoropropylene is particularly preferred in view of refractive index, solubility, transparency and availability.

As to the content of fluorine in the copolymer, the fluorine-containing vinyl monomer is introduced so that the fluorine content of the copolymer becomes preferably from 20 to 60% by mass, more preferably from 25 to 55% by mass, particularly preferably from 30 to 50% by mass.

The copolymer may contain a repeating unit having a (meth)acryloyl group.

The content of the repeating unit having a (meth)acryloyl group in the side chain amounts to preferably from 5 to 90% by mass, more preferably from 30 to 70% by mass, particularly preferably from 40 to 60% by mass, based on the mass of the copolymer.

With the above-described copolymers, other vinyl monomers may properly be copolymerized in addition to the repeating unit derived from the fluorine-containing vinyl monomer and the repeating unit having a (meth)acryloyl group in the side chain. As such vinyl monomers, plural ones may be used in combination according to the purpose. The vinyl monomers are introduced into the copolymer in the range of preferably from 0 to 65 mol %, more preferably from 0 to 40 mol %, particularly preferably from 0 to 30 mol %, of the copolymer.

The vinyl monomers that can be used together are not particularly limited and are exemplified by olefins, acrylates, methacrylates, styrene derivatives, vinyl ethers, vinyl esters, unsaturated carboxylic acids, acrylamides, methacrylamides and acrylonitrile derivatives.

Preferred embodiments of the copolymer to be used in the invention which comprises the repeating unit derived from the fluorine-containing vinyl monomer and the repeating unit having a (meth)acryloyl group are those which are represented by the following formula (1).

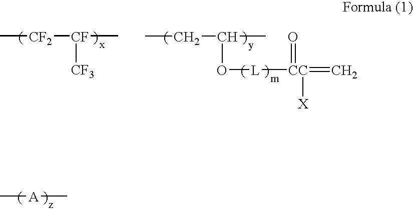

In the formula (1), L represents a linking group containing from 1 to 10 carbon atoms, more preferably a linking group containing from 1 to 6 carbon atoms, particularly preferably a linking group containing from 2 to 4 carbon atoms, which may have a straight chain, branched or cyclic structure and may have a hetero atom selected from among O, N and S.

Preferred examples thereof include *—(CH₂)₂—O—**, *—(CH₂)₂—NH—**, *—(CH₂)₄—O—**, *—(CH₂)₆-o-**, *—(CH₂)₂—O—(CH₂)₂—O—**, *—CONH—(CH₂)₃—O—**, *—CH₂CH(OH)CH₂—O—** and *—CH₂CH₂OCONH(CH₂)₃—O—** (wherein * represents a linking position to the polymer main chain side, and ** represents a linking position to the (meth)acrylol group side). m represents 0 or 1.

In the formula (1), X represents a hydrogen atom or a methyl group, with a hydrogen atom being preferred in view of curing reactivity.

In the formula (1), A represents a repeating unit derived from any vinyl monomer that is not particularly limited as long as it constitutes a monomer copolymerizable with hexafluoropropylene. A proper one can be selected in view of various factors such as adhesion properties to an undercoat layer such as a transparent support, dust-proof and stain-proof properties. A may be constituted by a single vinyl monomer or a plurality of vinyl monomers depending upon the purpose.

Preferred examples of the vinyl monomer include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate); (meth)acrylates such as methyl (meth)acrylate, ethyl (meth)acrylate, hydroxyethyl (meth)acrylate, glycidyl (meth)acrylate, allyl (meth)acrylate and (meth)acryloyloxypropyltrimethoxysilane; styrene derivatives such as styrene and p-hydroxymethylstyrene; and unsaturated carboxylic acids and the derivatives thereof such as crotonic acid, maleic acid and itaconic acid. Of these, vinyl ether derivatives and vinyl ester derivatives are more preferred, with vinyl ether derivatives being particularly preferred.

x, y and z each represents a mol % of each constituent satisfying 30≦x≦60, 5≦y≦70 and 0≦z≦65, preferably 35≦x≦55, 30≦y≦60 and 0≦z≦20, particularly preferably 40≦x≦55, 40≦y≦55 and 0≦z≦10.

As a particularly preferred embodiment of the copolymer, there are illustrated those which are represented by the formula (2).

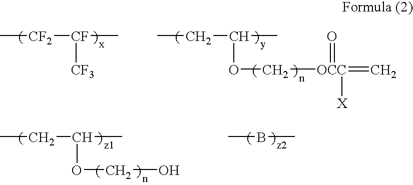

In the formula (2), X, x and y are the same as defined with respect to the formula (1), and preferred scopes thereof are also the same as described there.

n represents an integer of 2≦n≦10, preferably 2≦n≦6, particularly preferably 2≦n≦4.

B represents a repeating unit derived from any vinyl monomer and may be constituted by a single component or plural components. As examples thereof, those which have been described as examples of A in the formula (1) apply.

z1 and z2 each represents a mol % of each repeating unit and a value satisfying 0≦z1≦65 and 0≦z2≦65, preferably 0≦z1≦30 and 0≦z2≦10, particularly preferably 0≦z1≦10 and 0≦z2≦5. As a copolymer represented by the formula (2), those which satisfy 40≦x≦60, 30≦y≦60 and z2=0 are particularly preferred.

Preferred specific examples of the copolymers represented by the formula (1) or (2) and synthesizing processes thereof are described in, for example, JP-A-2004-45462, paragraphs [0043] to [0047].

Also, for the purpose of imparting stain-proof properties, a polysiloxane structure may be introduced into the fluorine-containing compound. Such introduction is preferably performed by block copolymerization or graft copolymerization. The content of the polysiloxane component is from 0.5% by mass to 10% by mass, preferably from 1% by mass to 5% by mass, based on the mass of the compound.

In the invention, the concentration of the fluorine-containing compound in the coating solution can properly be selected depending upon the use, and is preferably from 0.01% by mass to 60% by mass, more preferably from 0.5 to 50% by mass, particularly preferably from about 1% to about 20% by mass.

The low refractive index layer can contain additives such as fillers (e.g., inorganic fine particles and organic fine particles), slipping agents (e.g., a polysiloxane compound such as dimethylsilicone), organosilane compounds and the derivatives thereof, a binder and a surfactant. In particular, it is preferred to add fillers (e.g., inorganic fine particles and organic fine particles) and slipping agents (e.g., a polysiloxane compound such as dimethylsilicone).

Preferred fillers and slipping agents to be used in the low refractive index layer will be described below.

(Preferred Fillers for the Low Refractive Index Layer)

Addition of fillers (e.g., inorganic fine particles or organic fine particles) is preferred in the point of improving physical strength (e.g., scratching resistance) of the low refractive index layer. Among them, silicon dioxide (silica) having a low refractive index, hollow silica, silica having fine pores, fluorine-containing particles (e.g., magnesium fluoride and calcium fluoride or barium fluoride) are preferred, with silicon dioxide (silica) and hollow silica being particularly preferred. These may have been subjected to chemical surface treatment.

The addition amount of the fillers is preferably from 5% by mass to 70% by mass, more preferably from 10% by mass to 50% by mass, particularly preferably from 20% by mass to 40% by mass, based on the total mass of the low refractive index layer in view of physical strength and avoiding white turbidity.

The fillers have an average particle size of preferably from 20% to 100%, more preferably from 30% to 80%, particularly preferably from 30% to 50%, based on the thickness of the low refractive index layer.

The fillers may be used in combination of two or more kinds thereof.

In the case where the fillers to be added to the low refractive index layer are silicon dioxide fine particles, it is particularly preferred to use hollow silicon dioxide fine particles. The hollow silicon dioxide fine particles have a refractive index of preferably from 1.17 to 1.45, more preferably from 1.17 to 1.40, still more preferably from 1.17 to 1.37. Here, the refractive index of hollow silicon dioxide fine particles is represented in terms of a refractive index of entire particles. Addition of them serves to reduce the refractive index of the low refractive index layer.

When the radius of the hollow within each particle of the hollow silicon dioxide fine particles is represented by a and the radius of the outer shell of each particle is represented by b, the void ratio x is represented by the following numerical formula (1).
x=(4πa³/3)/(4πb³/3)×100 Numerical formula (1)

The void ratio x is preferably from 10 to 60%, more preferably from 20 to 60%, most preferably from 30 to 60%.

(Preferred Slipping Agents for the Low Refractive Index Layer)

Addition of the slipping agent is preferred in the point of improving physical strength (e.g., scratching resistance) and stain-proof properties.

As the slipping agent, there are illustrated fluorine-containing ether compounds (perfluoropolyethers and the derivatives thereof) and polysiloxane compounds (e.g., dimethylpolysiloxane and the derivatives thereof), with polysiloxane compounds being preferred.

Preferred examples of the polysiloxane compound include those compounds which contain plural dimethylsilyloxy units as repeating units and which have a substituent at at least either of the terminal end or the side chain thereof.

The compound containing simethylsilyloxy units as repeating untis may contain other structural units (substituents) than dimethylsilyloxy. Such substituents may be the same or different, and plural substituents are preferred to exist.

Preferred examples of the substituent include a (meth)acryloyl group, a vinyl group, an aryl group, a cinnamoyl group, an epoxy group, an oxetanyl group, a hydroxyl group, a fluoroalkyl group, a polyoxyalkylene group, a carboxyl group and an amino group.

The molecular mass of the slipping agent is not particularly limited, but is preferably 100,000 or less, particularly preferably 50,000 or less, most preferably from 3,000 to 30,000. The content of Si atom in the siloxane compound is not particularly limited, but is preferably 5% by mass or more, particularly preferably from 10% by mass to 60% by mass, most preferably from 15 to 50% by mass.

As specific compounds of polysiloxane, there are illustrated commercially available ones such as KF-100T, X-22-169AS, KF-102, X-22-37011E, X-22-164B, X-22-164C, X-22-5002, XC-22-173B, X-22-174D, X-22-167B, X-22-161AS, X-22-174DX, X-22-2426, X-22-170DX, X-22-176D and X-22-1821 (manufactured by Shin-Etsu Chemical Co., Ltd.), AK-5, AK-30 and AK-32 (manufactured by Toagosei Co., Ltd.), SILAPLANE FM0275, FM-0721, FM-0725, FM-7725, DMS-U22, RMS-033, RMS-083 and UMS-182 (manufactured by Chisso Corp.). The polysiloxanes can also be prepared by introducing a cross-linkable or polymerizable functional group to hydroxyl group, amino group or mercapto group which commercially polysiloxane compounds have.

As preferred specific examples of the polysiloxane compounds, there can be illustrated those compounds which are described in JP-A-2003-329804, paragraphs [0041] to [0045], though not limitative at all.

The addition amount of at least either of the polysi8loxane compound and the derivative thereof is preferably from 0.05 to 30% by mass, more preferably from 0.1 to 20 parts by mass, based on the mass of the whole solid components in the outermost layer.

(Low Refractive Index Layer and Method for Forming It)

The low refractive index layer is preferably formed by coating a coating solution prepared by dissolving or dispersing the fluorine-containing compound and, as needed, the filler and at least either of the polysiloxane compound and the derivative thereof.

Preferred examples of the solvent include ketones (e.g., acetone, methyl ethyl ketone, methyl isobutyl ketone and cyclohexanone), esters (e.g., ethyl acetate and butyl acetate), ethers (e.g., tetrahydrofuran and 1,4-dioxane), alcohols (e.g., methanol, ethanol, isopropyl alcohol, butanol and ethylene glycol), aromatic hydrocarbons (e.g., toluene and xylene) and water.

Particularly preferred solvents are ketones, aromatic hydrocarbons and esters, with ketones being most preferred. Of ketones, methyl ethyl ketone, methyl isobutyl ketone and cyclohexanone are particularly preferred. The content of the ketone series solvent in the solvents contained in the coating solution is preferably 10% by mass or more, more preferably 30% by mass or more, still more preferably 60% by mass or more, based on the mass of the whole solvents.

Two or more kinds of solvents may be used in combination thereof.

With the fluorine-containing compound having a cross-linkable or polymerizable functional group, it is preferred to conduct cross-linking or polymerization reaction of the fluorine-containing compound simultaneously with or after coating of the coating solution for forming the low refractive index layer to thereby form the layer.

As the radical polymerization initiator, those compounds are preferred which generate radical by the action of heat or by the action of light. As the polymerization initiators, those which have been described with respect to the optically functional layer can be used. It is preferred to thermally cure or cure by irradiation with light after coating of the coating solution in the same manner as with the optically functional layer. With compounds having a cation-cross-linkable or cation-polymerizable functional group, it is preferred to cause cross-linking or polymerization reaction by using a cation polymerization initiator, particularly, a photo cation polymerization initiator.

As the binder, other materials than the fluorine-containing compounds, for example, fluorine-free high molecular compounds and monomers having a polymerizable group may be used.

The thickness of the low refractive index layer is preferably from 30 to 200 nm, more preferably from 50 to 150 nm, particularly preferably from 60 to 120 nm. In the case of using the low refractive index layer as a stain-proof layer, the thickness thereof is preferably from 3 to 50 nm, more preferably from 5 to 35 nm, particularly preferably from 7 to 25 nm.

In order to improve physical strength of the optical film, the low refractive index layer preferably has a surface kinetic friction coefficient of 0.25 or less. The term “kinetic friction coefficient” as used herein means a kinetic friction coefficient between the surface of the film and a stainless steel-made ball of 5 mm in diameter measured by moving the ball along the surface of the film at a speed of 60 cm/min while applying the ball a load of 0.98 N. The surface kinetic friction coefficient is preferably 0.17 or less, particularly preferably 0.15 or less.

Also, in order to improve stain-proof performance of the optical film, the contact angle of the film for water is preferably 90° or more, more preferably 95° or more, particularly preferably 100° or more.

Further, the contact angle of the low refractive index layer for water is desirably unchanged between before and after the saponification treatment to be described hereinafter, with the amount of change in the contact angle between before and after the saponification treatment being preferably within 10°, particularly preferably within 5°.

Regarding the haze of the low refractive index layer, the smaller the haze, the more preferred. The haze is preferably 3% or less, more preferably 2% or less, particularly preferably 1% or less.

The strength of the low refractive index layer measured by the pencil hardness test according to JIS K5400 is preferably H or more, more preferably 2H or more, most preferably 3H or more. Also, with the refractive index layer, a smaller abrasion amount of a test piece after the taper test according to JIS K5400 is more preferred.

To the low refractive index layer may be added, in addition to the above-described components (the fluorine-containing compound, the photo polymerization initiator, the photo sensitizer, the filler, the slipping agent, the binder, etc.), a surfactant, an antistatic agent, a coupling agent, a thickening agent, a coloration-preventing agent, a coloring agent (a pigment or a dye), a defoaming agent, a leveling agent, a fire retardant, a UV ray absorbent, an infrared ray absorbent, an adhesion-imparting agent, a polymerization inhibitor, an antioxidant and a surface-modifying agent.

The refractive index of the low refractive index layer is preferably from 1.20 to 1.55, more preferably from 1.30 to 1.50, still more preferably from 1.35 to 1.48, particularly preferably from 1.37 to 1.45.

It is also preferred to incorporate in the low refractive index layer a compound selected from the group consisting of an organosilane compound represented by the formula (a) to be described hereinafter and the derivative thereof (e.g., a hydrolyzate and a cross-linked silicon compound produced by condensation of the hydrolyzate).

(Antistatic Layer)

In order to prevent adhesion of dust (e.g., dirt) onto the surface of the optical film of the invention, it is also preferred to use an antistatic layer using tin oxide, antimony-doped tin oxide (ATO), indium oxide, tin-doped indium oxide (ITO), zinc oxide or aluminum-doped zinc oxide as an electrically conductive material. The dust-proof properties are developed by reducing the surface resistance value of the film surface. The surface resistance value is preferably 1×10¹³ Ω/□ or less, more preferably 1×10¹² Ω/□ or less, still more preferably 1×10¹⁰ Ω/□ or less.

The antistatic layer is preferably provided between the anti-glare layer and the low refractive index layer or between the transparent support and the anti-glare layer.

(Other Coating Layer)

In order to impart physical strength, a hard coat layer may be provided between the transparent support and the outermost layer of the optical film of the invention.

The hard coat layer is preferably formed by cross-linking or polymerization reaction of an ionization radiation-curable compound. For example, the hard coat layer can be formed by coating on a transparent support a coating composition containing an ionization radiation-curable, multi-functional monomer having a (meth)acryloyl group, a vinyl group, a styryl group or an allyl group, and then conducting cross-linking or polymerization reaction.

(Transparent Support)

The transparent support is preferably a plastic film. Examples of the plastic film include films of a cellulose ester (e.g., triacetyl cellulose, diacetyl cellulose, propionyl cellulose, butyryl cellulose, acetylpropionyl celluolose or nitrocellulose), a polyamide, a polycarbonate, a polyester (e.g., polyethylene terephthalate, polyethylene naphthalate, poly-1,4-cyclohexanedimethyleneterephthalate, polyethylene-1,2-diphenoxyethane-4,4′-dicarboxylate or polybutylene terephthalate), a polystyrene (e.g., syndiotactic polystyrene), a polyolefin (e.g., polypropylene, polyethylene or polymethylpentene), polysulfone, polyethersulfone, polyallylate, polyether imide, polymethyl methacrylate and polyether ketone. Of these, triacetyl cellulose, polycarbonate, polyethylene terephthalate and polyethylene naphthalate are preferred. Also, a cellulose acylate film containing a retardation decreasing compound so that Re(λ) and Rth(λ) defined by the following formulae (I) and (II), respectively, satisfy the following formulae (III) and (IV) at the same time may be used.
Re(λ)=(nx−ny)×d (I)
Rth(λ)={(nx+ny)/2−nz}×d (II)
0≦Re₍₆₃₀₎≦10 and |Rth₍₆₃₀₎|≦25 (III)
|Re₍₄₀₀₎₋Re₍₇₀₀₎|≦10 and |Rth₍₄₀₀₎−Rth₍₇₀₀₎|≦35 (IV)
[In the formulae, Re(λ) represents an in-plane retardation value (unit: nm) at a wavelength of λ nm, Rth(λ) represents a retardation value in a thickness direction (unit: nm) at a wavelength of λnm. nx represents a refractive index in the slow axis direction within the film, ny represents a refractive index in the fast axis within the film, nz represents a refractive index in the film thickness direction, and d represents a thickness of the film.]

Of these, a triacetyl cellulose film is preferred in the case of using for a liquid crystal display device.

When the transparent support is a triacetyl cellulose film, a triacetyl cellulose film formed by casting a triacetyl cellulose dope having been prepared by dissolving triacetyl cellulose in a solvent according to either a single layer-casting method or a plural layer-cocasting method is preferred.

In particular, in view of protection of environment, a triacetyl cellulose film formed by using a triacetyl cellulose dope having been prepared by dissolving triacetyl cellulose in a solvent which substantially does not contain dichloromethane according to the low-temperature dissolving method or the high-temperature dissolving method is preferred.

A triacetyl cellulose film to be preferably used in the invention is illustrated in Hatsumei Kyokai Kokai Giho (Kogi Bango 2001-1745).

The thickness of the transparent support is not particularly limited, but is preferably from 1 to 300 μm, more preferably from 30 to 150 μm, particularly preferably from 40 to 120 μm, most preferably from 40 to 100 μm.

The light transmittance of the transparent support is preferably 80% or more, more preferably 86% or more.

The transparent support having a smaller haze is more preferred, and the haze is preferably 2.0% or less, more preferably 1.0% or less.

The refractive index of the transparent support is preferably from 1.40 to 1.70.

To the transparent support may be added an infrared ray absorbent or a UV ray absorbent. The addition amount of the infrared ray absorbent is preferably from 0.01 to 20% by mass, more preferably from 0.05 to 10% by mass, based on the mass of the transparent support.

Also, particles of an inert inorganic compound may be added to the transparent support as a slipping agent. Examples of the inorganic compound include SiO₂, TiO₂, BaSO₄, CaCO₃, talc and kaolin.

The transparent support may be subjected to surface treatment. Examples of the surface treatment include chemical treatment, mechanical treatment, corona discharge treatment, flame treatment, UV ray-irradiation treatment, high-frequency treatment, glow discharge treatment, active plasma treatment, laser treatment, mixed acid treatment and ozone-oxidation treatment. Glow discharge treatment, UV ray-irradiation treatment, corona discharge treatment and flame treatment are preferred, with glow discharge treatment and corona discharge treatment being particularly preferred.

(Organosilane Compounds)

In view of improving physical strength (e.g., scratching resistance) of the film and adhesion between the film and a layer adjacent thereto, it is preferred to add at least one compound selected from among organosilane compounds and the derivatives thereof to any one of the layers provided on the transparent support.

As the organosilane compounds and the derivatives thereof, those compounds which are represented by the following formula (a) and the derivatives thereof can be used. Preferred are organosilane compounds having a hydroxyl group, a mercapto group, a carboxyl group, an epoxy group, an alkyl group, an alkoxysilyl group, an acyloxy group or an acylamino group, and particularly preferred ared organosilane compounds having an epoxy group, a polymerizable acyloxy group (e.g., (meth)acryloyl), a polymerizable acylamino group (e.g., acrylamino or methacrylamino) or an alkyl group.
(R¹⁰)ₛ—Si(Z)₄₋ₛ Formula (a)

In the formula (a), R¹⁰ represents a substituted or unsubstituted alkyl group or a substituted or unsubstituted aryl group. As the alkyl group, an alkyl group containing from 1 to 30 carbon atoms is preferred, with an alkyl group containing from 1 to 16 carbon atoms being more preferred.

Z represents a hydroxyl group or a hydrolysable group. As Z, there are illustrated an alkoxy group (containing preferably from 1 to 5 carbon atoms; e.g., a methoxy group or an ethoxy group), a halogen atom (e.g., Cl, Br or I) or R²COO (wherein R² preferably represents a hydrogen atom or an alkyl group containing from 1 to 6 carbon atoms; e.g., CH₃COO or C₂H₅COO). Of these, an alkoxy group is preferred, with a methoxy group or an ethoxy group being particularly preferred.

s represents an integer of from 1 to 3, preferably 1 or 2.

When plural R¹⁰s and Zs exist, plural R¹⁰s and Zs may be the same or different, respectively.

Substituents included in R10 are not particularly limited, but are exemplified by a halogen atom, a hydroxyl group, a mercapto group, a carboxyl group, an epoxy group, an alkyl group (e.g., methyl, ethyl, i-propyl, propyl or t-butyl), an aryl group, an aromatic hetero ring group, an alkoxy group, an aryloxy group, an alkylthio group, an arylthio group, an alkenyl group, an acyloxy group, an alkoxycarbonyl group, an aryloxycarbonyl group, a carbamoyl group, an acylamino group and a cycloalkyl group. These substituents may further be substituted.

It is also preferred that the compounds represented by the formula (a) are those organosilane compounds which have a vinyl-polymerizable substituent and are represented by the following formula (b). 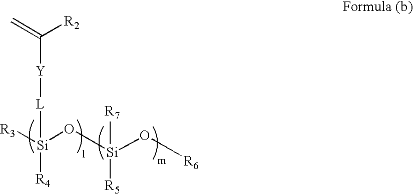
In the formula (b), R₂ represents a hydrogen atom, a methyl group, a methoxy group, an alkoxycarbonyl group, a cyano group, a fluorine atom or a chlorine atom. Of these, a hydrogen atom, a methyl group, a methoxy group, a methoxycarbonyl group, a cyano group, a fluorine atom and a chlorine atom are preferred, a hydrogen atom, a methyl group, a methoxycarbonyl group, a fluorine atom and a chlorine atom are more preferred, and a hydrogen atom and a methyl group are particularly preferred.

Y represents a single bond, *—COO—**, *—CONH—** or *—O—**, preferably a single bond, *—COO—** or *—CONH—**, more preferably a single bond or *—COO—**, particularly preferably *—COO—**. * represents a position of binding to ═C(R₂)—, and ** represents a position of binding to L.

L represents a divalent linking group. Specifically, a substituted or unsubstituted alkylene group or a substituted or unsubstituted arylene group is preferred. As substituents, a halogen atom, a hydroxyl group, a mercapto group, a carboxyl group, an epoxy group, an alkyl group and an aryl group are illustrated. These substituents may further be substituted.

l represents a number (mol fraction) satisfying 100-m (wherein m represents a number (mol fraction) of from 0 to 50). m more preferably represents a number of from 0 to 40, with a number of from 0 to 30 being more preferred.

R₃ to R₅ each represents a monovalent group, preferably a halogen atom, a hydroxyl group, an unsubstituted alkoxy group or an unsubstituted alkyl group. R₃ to R₅ each represents more preferably a chlorine atom, a hydroxyl group or an unsubstituted alkoxy group containing from 1 to 6 carbon atoms, still more preferably a hydroxyl group or an alkoxy group containing from 1 to 3 carbon atoms, particularly preferably a hydroxyl group or a methoxy group.

R₆ represents a hydrogen atom or an alkyl group. As the alkyl group, a methyl group or an ethyl group is preferred. R₆ is particularly preferably a hydrogen atom or a methyl group.

R₇ represents a substituted or unsubstituted alkyl group or a substituted or unsubstituted aryl group. As the alkyl group, an alkyl group containing from 1 to 30 carbon atoms is preferred, with an alkyl group containing from 1 to 16 carbon atoms being more preferred.

When plural R₄s, R₅s and R₇s exist, plural R₄s, R₅s and R₇s may be the same or different, respectively.

Compounds represented by the formula (a) may be used in combination of two or more thereof. In particular, compounds of the formula (b) are synthesized from two kinds of the compounds represented by the formula (a). Specific examples of starting materials for compounds represented by the formulae (a) and (b) are shown below which, however, do not limit the invention in any way.

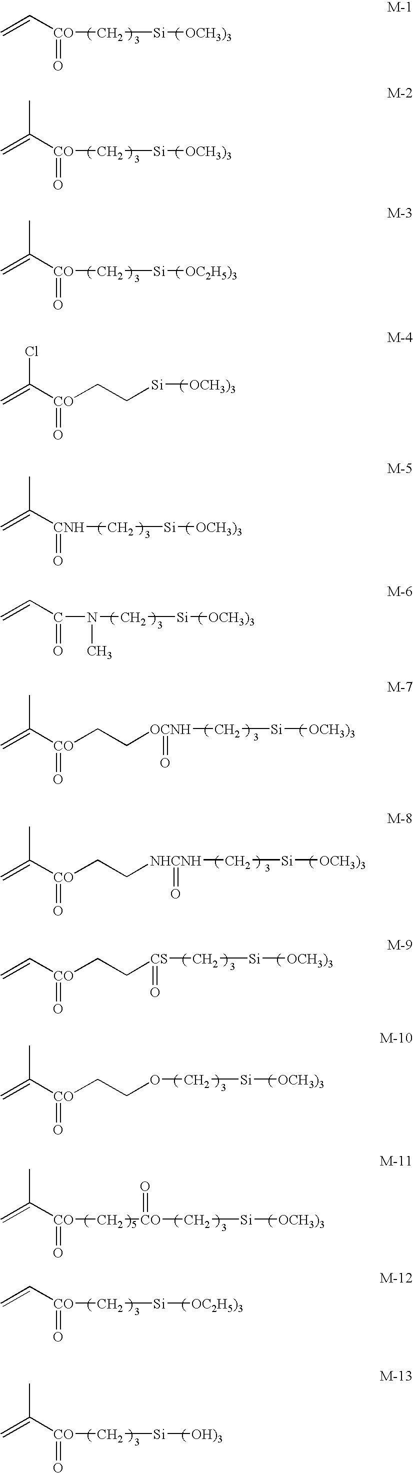

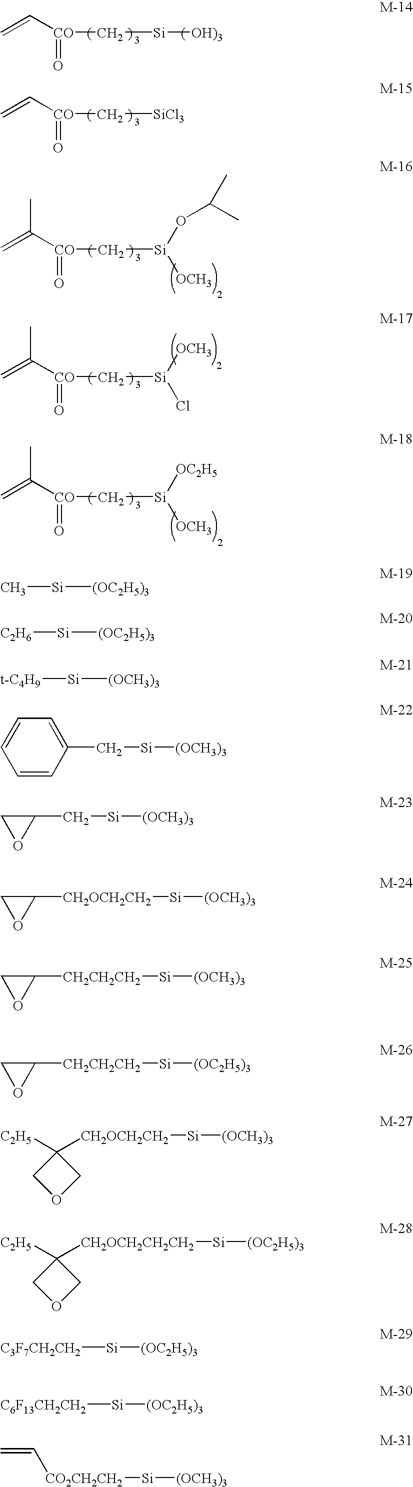

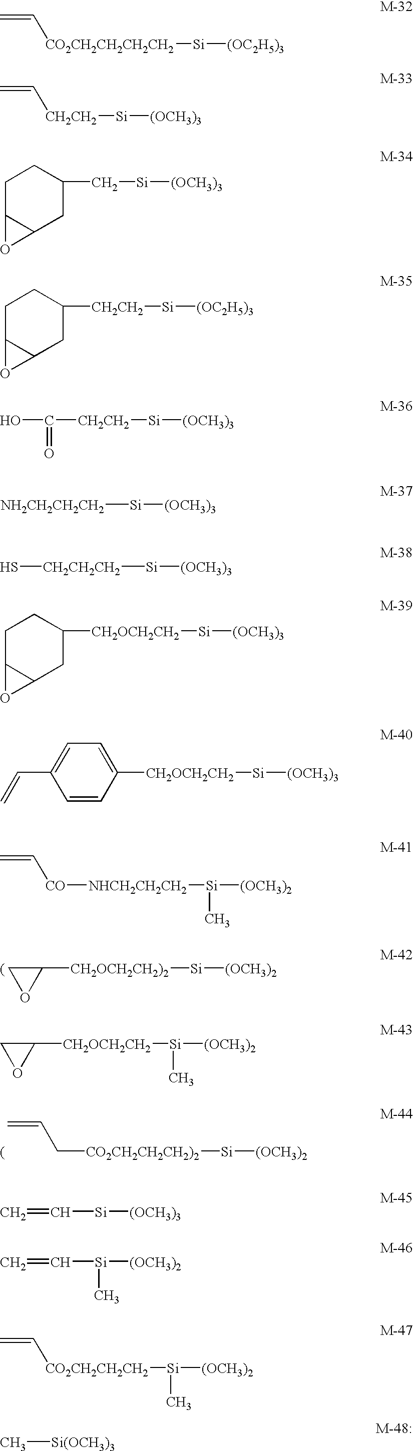

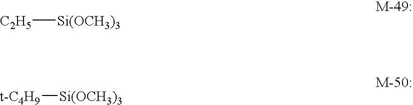

Of these, (M-1), (M-2), (M-25), (M-48) and (M-49) are particularly preferred.

In order to obtain the advantages of the invention, the content of the organosilane having the vinyl-polymerizable group in the hydrolyzate of organosilane and/or the partial condensate thereof is preferably from 30% by mass to 100% by mass, more preferably from 50% by mass to 100% by mass, still more preferably from 70% by mass to 100% by mass, particularly preferably from 90% by mass to 100% by mass. In view of generation of solid components, turbidity of the solution, deterioration of pot life and control of molecular mass and since properties (e.g., scratching resistance of the anti-reflection film) can easily be improved in the case of conducting polymerization due to a small content of the polymerizable group, the content of the vinyl-polymerizable group-containing organosilane is preferably 30% by mass or more.

The sol component to be used in the invention is prepared by hydrolysis and/or partial condensation of the organosilane.

The hydrolysis.condensation reaction is conducted by adding water in an amount of from 0.05 to 2.0 mols, preferably from 0.1 to 1.0 mol, per mol of the hydrolysable group (X), and stirring at a temperature of from 25 to 100° C. in the presence of the catalyst to be used in the invention.

With at least either of the hydrolyzate of organosilane and the partial condensate thereof, the mass-average molecular mass of either of the hydrolyzate of organosilane having a vinyl-polymerizable group and the partial condensate thereof is preferably from 450 to 20,000, more preferably from 500 to 10,000, with a component of less than 300 in molecular mass being excluded.

Of the components of the organosilane hydrolyzate and/or the partial condensate thereof having a molecular mass of 300 or more, the content of components of 20,000 or more is preferably 10% by mass or less.

The hydrolyzate of the organosilane compound and the partial condensate thereof to be used in the invention will be described in detail below.

The hydrolysis reaction of organosilane and subsequent condensation reaction are generally conducted in the presence of a catalyst. As the catalyst, there are illustrated inorganic acids such as hydrochloric acid, sulfuric acid and nitric acid; organic acids such as oxalic acid, acetic acid, butyric acid, maleic acid, citric acid, formic acid, methanesulfonic acid and toluenesulfonic acid; inorganic bases such as sodium hydroxide, potassium hydroxide and ammonia; organic salts such as triethylamine and pyridine; metal alkoxides such as triisopropoxyaluminum, tetrabutoxyzirconium, tetrabutyl titanate and dibutyltin dilaurate; metal chelates having as a center metal Zr, Ti or Al; and F-containing compounds such as KF and NH₄F.

These catalysts may be used independently or in combination of two or more thereof.

The hydrolysis·condensation reaction can be conducted in the absence of solvent or in a solvent but, in order to uniformly mix the reacting components, it is preferred to use an organic solvent. For example, alcohols, aromatic hydrocarbons, ethers, ketones and esters are preferred.

The hydrolysis·condensation reaction is conducted by adding water in an amount of from 0.05 to 2.0 mols, preferably from 0.1 to 1.0 mol, per mol of the hydrolysable group of the organosilane, and stirring at a temperature of from 25 to 100° C. in the presence or absence of solvent and in the presence of the catalyst.

In the invention, the hydrolysis is conducted preferably in the presence of at least one metal chelate compound containing an alkyl group or an alkoxy group containing from 1 to 10 carbon atoms as a ligand and containing a metal selected from among Zr, Ti and Al as a center metal.

As the metal chelate compound, a compound selected from compounds represented by the formula of Zr(OR³)ₚ₁(R⁴COCHCOR⁵)ₚ₂, Ti(OR³)_{q1}(R⁴COCHCOR⁵)_{q2} and Al(OR³)ᵣ₁(R⁴COCHCOR⁵)ᵣ₂ is preferred.

When plural R³s and R⁴s exist in the metal chelate compound, they may be the same or different and each represents an alkyl group containing from 1 to 10 carbon atoms, specifically an ethyl group, a n-propyl group, an i-propyl group, a n-butyl group, a sec-butyl group, a t-butyl group, a n-pentyl group or a phenyl group.

When plural R⁵s exist, they may be the same or different from each other, and each represents the same alkyl group containing from 1 to 10 carbon atoms as described above, or an alkoxy group containing from 1 to 10 carbon atoms, such as a methoxy group, an ethoxy group, a n-propoxy group, an i-propoxy group, a n-butoxy group, a sec-butoxy group or a t-butoxy group.

Also, p1, p2, q1, q2, r1 and r2 in the metal chelate compound each represents an integer which is determined so as to satisfy the equations of p1+p2=4, q1+q2=4 and r1+r2=3.

Preferred specific examples of the metal chelate compound include tri-n-butoxyethylacetoacetatozirconium, diisopropoxybis(acetylacetonato)titanium, diisopropoxyethylacetoacetatoaluminum and tris(ethylacetoacetato)aluminum. These metal chelate compounds may be used independently or as a mixture of two or more thereof. It is also possible to use a partially hydrolyzed product of the metal chelate compound.

It is preferred to add at least either of a β-diketone compound and a ketoester compound to the coating solution for forming the functional layer and the low refractive index layer to be used in the invention, in addition to the above-described composition containing the sol component and the metal chelate compound. A more detailed description will be given below.

It is at least either of a β-diketone compound and a β-ketoester compound represented by the formula of R⁴COCH₂COR⁵ that is to be used in the invention. They function as an agent for improving stability of the composition to be used in the invention. Preferred specific examples of the β-diketone compound and the β-ketoester compound include ethyl acetoacetate and acetylacetone.

Regarding the content of the hydrolyzate and partial condensate of the organosilane compound, a small content is preferred with a comparatively thin low refractive index layer, whereas a large content is preferred with a thick function layer. In consideration of development of the effect, refractive index, form and surface state of the film, the content is preferably from 0.1 to 50% by mass, more preferably from 0.5 to 30% by mass, most preferably from 1 to 15% by mass, based on the mass of the total solid components in the layer containing them (layer to which they are added).

At least one compound selected from the organosilane compounds and the derivatives thereof preferably has the ability of cross-linking or polymerizing with other components in the layer containing them for improving physicalo strength (e.g., scratching resistance) of the film. For this purpose, it is preferred for the organosilane compound to have a cross-linkable or polymerizable group or to use as the inorganic particles or the binder a compound which has a functional group capable of cross-linking or polymerizing with the organosilane compound.

Layers to which the organosilane compound is preferably added are an antistatic layer, a hard coat layer, an anti-glare layer, a light-diffusing layer, a high refractive index layer, a low refractive index layer and the outermost layer, more preferably a hard coat layer, an anti-glare layer, a light-diffusing layer, a low refractive index layer and the outermost layer, particularly preferably the outermost layer and an adjacent layer to the outermost layer.

Method for Forming the Optical Film

In the invention, each layer constituting the optical film is preferably formed by a coating method. In the case of forming the layers according to a coating method, each layer can be formed according to a dip coating method, an air-knife coating method, a curtain coating method, a roller coating method, a wire-bar coating method, a gravure coating method, a micro-gravure coating method, an extrusion coating method (described in U.S. Pat. No. 2,681,294) or a die coating method (described in, e.g., JP-A-2003-20097, JP-A-2003-211052, JP-A-2003-236434, JP-A-2003-260400 and JP-A-2003-260402). Two or more layers may be coated simultaneously. For such simultaneously coating methods, reference can be made to U.S. Pat. Nos. 2,761,791, 2,941,898, 3,508,947 and 3,526,528, and Kotingu Kogaku (Coating Engineering) by Yuji Harasaki, p. 253, Asakura Shoten (1973). A wire-bar coating method, a gravure coating method, a micro-gravure coating method and a die coating method are preferred. Of these, a micro-gravure coating method and a die coating method are particularly preferred, with a die coating method being most preferred.

The micro-gravure coating method is a coating method which is characterized in that a gravure roll of from about 10 to about 100 mm, preferably from about 20 to about 50 mm, in diameter having engraved on the whole periphery thereof a gravure pattern is positioned under the support and is rotated in the reverse direction to the support-conveying direction and that an excel coating solution is removed from the surface of the gravure roll by means of a doctor blade to thereby transfer a definite amount of the coating solution to the support.

In the micro-gravure coating method, the line number of a gravure pattern engraved on the gravure roll is preferably from 50 to 800 lines/inch, more preferably from 100 to 300 lines/inch. The depth of the gravure pattern is preferably from 1 to 600 μm, more preferably from 5 to 200 μm. The rotation number of the gravure roll is preferably from 3 to 800 rpm, more preferably from 5 to 200 rpm. The support-conveying speed is preferably from 0.5 to 100 m/min, more preferably from 1 to 50 m/min.

In the die coating method, a coating solution is applied as a bead to a web continuously conveyed with being supported on a back-up roller through a slot die wherein a pocket is formed, thus a coating film being formed on the web. Coating with a wet film thickness of several ten μm or less can be conducted with good accuracy by adequately adjusting the distance between the tip of the slot die and the web on the upstream side and on the downstream side with respect to the slot member in the web-running direction.

In forming each layer of the optical film according to the coating method, it is preferred to add a surface state-improving agent to the coating composition to be used for forming the layer. Hereinafter, the surface state-improving agent will be described.

(Surface State-Improving Agent)

In order to prevent surface state troubles (e.g., uneven coating, uneven drying, spot defects, etc.), at least one of fluorine-containing surface state-improving agents and silicone series surface state-improving agents is preferably added to a coating composition to be used for forming any of the layers on the transparent support of the invention.

The surface state-improving agent preferably changes the surface tension of the coating composition by 1 mN/m or more. To change the surface tension of the coating composition by 1 mN/m or more means that the surface tension of the coating composition after addition of the surface state-improving agent changes by 1 mN/m or more in comparison with the surface tension of the coating composition before addition of the surface state-improving agent including the concentrating step in the coating/drying process.

Preferably, the surface state-improving agent exhibits the effect of reducing the surface tension of the coating composition by 1 mN/m or more, more preferably 2 mN/m or more, particularly preferably 3 mN/m or more.

As preferred examples of the fluorine-containing surface state-improving agent, there are illustrated compounds containing a fluoro-aliphatic group (hereinafter abbreviated as “fluorine-containing surface state-improving agents). In particular, acrylic resins and methacrylic resins containing a repeating unit corresponding to a monomer of the following formula (i) and a repeating unit corresponding to a monomer of the following formula (ii); and copolymers thereof with a vinyl monomer copolymerizable therewith are preferred.

As such monomers, those which are described in Polymer Handbook, 2^{nd} ed., J. Brandrup, Wiley Interscience (1975), Chapter 2, pp. 1 to 483 are preferably used.

For example, there can be illustrated compounds having one addition-polymerizable unsaturated bond selected from among acrylic acid, methacrylic acid, acrylates, methacrylates, acrylamides, methacrylamides, allyl compounds, vinyl ethers and vinyl esters.

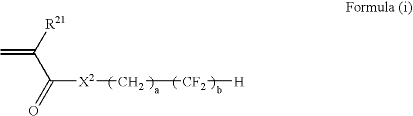

In the formula (i), R²¹ represents a hydrogen atom, a halogen atom or a methyl group, more preferably a hydrogen atom or a methyl group. X² represents an oxygen atom, a sulfur atom or —N(R²²)—, more preferably an oxygen atom or —N(R²²)—, particularly preferably an oxygen atom. R²² represents a hydrogen atom or an alkyl group containing from 1 to 8 carbon atoms, preferably a hydrogen atom or an alkyl group containing from 1 to 4 carbon atoms, particularly preferably a hydrogen atom or a methyl group. a represents an integer of from 1 to 6, more preferably from 1 to 3, particularly preferably 1. b represents an integer of from 1 to 18, more preferably from 4 to 12, particularly preferably from 6 to 8.

Two or more kinds of the monomers containing a fluoro-aliphatic group and represented by the formula (i) may be contained as constituents in the fluorine-containing surface state-improving agent.

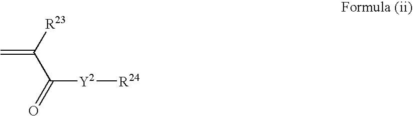

In the formula (ii), R²³ represents a hydrogen atom, a halogen atom or a methyl group, more preferably a hydrogen atom or a methyl group. Y² represents an oxygen atom, a sulfur atom or —N(R²⁵)—, more preferably an oxygen atom or —N(R²⁵)—, particularly preferably an oxygen atom. R²⁵ represents a hydrogen atom or an alkyl group containing from 1 to 8 carbon atoms, preferably a hydrogen atom or an alkyl group containing from 1 to 4 carbon atoms, particularly preferably a hydrogen atom or a methyl group.

R²⁴ represents a hydrogen atom, a substituted or unsubstituted, straight, branched or cyclic alkyl group containing from 1 to 20 carbon atoms, an alkyl group containing a poly(alkyleneoxy) group or a substituted or unsubstituted aromatic group (e.g., a phenyl group or a naphthyl group), more preferably aa straight, branched or cyclic alkyl group containing from 1 to 12 carbon atoms or an aromatic group containing from 6 to 18 carbon atoms in all, still more preferably a straight, branched or cyclic alkyl group containing from 1 to 8 carbon atoms. The poly(alkyleneoxy) group will be described below.

The poly(alkyleneoxy) group is a group containing —(OR)— as a repeating unit wherein R represents an alkylene group containing from 2 to 4 carbon atoms (e.g., —CH₂CH₂—, —CH₂CH₂CH₂—, —CH(CH₃)CH₂— or —CH(CH₃)CH(CH₃)—).

The oxyalkylene units (—OR—) in the poly(oxyalkylene) group may be the same, or two or more different kinds of oxyalkylene units may be irregularly distributed therein. Further, a block of straight or branched oxypropylene units or a block of oxyethylene units may exist therein.

This poly(oxyalkylene) chain may include those which contain one or more chain bonds (e.g., —CONH—Ph—NHCO— or —S— wherein Ph represents a phenylene group). When the chain bond has a valency of 3 or more, it provides a means for obtaining a branched oxyalkylene unit. In the case of using this copolymer in the invention, the molecular mass of the poly(oxyalkylene) group is suitably from 250 to 3,000.

Poly(oxyalkylene) acrylate and methacrylate can be obtained by reacting a commercially available hydroxypoly(oxyalkylene) material, e.g., Pluronic (manufactured by ADEKA CORPORATION), Carbowax (manufactured by Glyco Products), Triton (manufactured by Rohm and Haas) and P.E.G. (manufactured by Dai-ichi Kogyo Seiyaku) with acrylic acid, methacrylic acid, acryl chloride, methacryl chloride or acrylic acid anhydride in a known manner. Alternatively, poly(oxyalkylene) diacrylate or the like produced in a known manner can also be used.

With the fluorine-containing surface state-improving agent to be used in the invention, the content of the fluoro-aliphatic group-containing monomer represented by the formula (i) is preferably 50 mol % or more, more preferably from 70 to 100 mol %, particularly preferably from 80 to 100 mol %, based on the amount of the whole monomers.

The mass-average molecular mass of the fluorine-containing surface state-improving agent to be used in the invention is preferably from 3,000 to 100,000, more preferably from 6,000 to 80,000, still more preferably from 8,000 to 60,000.

Here, the mass-average molecular mass is a molecular mass in terms of polystyrene detected by a differential refractometer using a GPC analyzing apparatus using a column of TSKgel GMHxL, TSKgel G4000HxL and TSKgel G2000HxL (all being trade names of Toso K. K.) and THF as a solvent. The content is a percentage of a peak area within the above-described molecular mass range, taking the peak area of components of 300 or more in molecular mass as 100%.

Further, the addition amount of the fluorine-containing surface state-improving agent to be used in the invention is preferably from 0.001 to 5% by mass, more preferably from 0.005 to 3% by mass, still more preferably from 0.01 to 1% by mass, based on the mass of the coating composition of the layer to which the agent is added.

Examples of a specific structure of the fluorine-containing surface state-improving agent according to the invention are shown below which, however, do not limit the invention in any way. Additionally, numerals in the formula represent mol fractions of individual monomers. Mw represents a mass-average molecular mass.

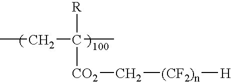

| | R | n | Mw |
|---|---|---|---|
| F-1 | H | 4 | 8000 |
| F-2 | H | 4 | 16000 |
| F-3 | H | 4 | 33000 |
| F-4 | CH₃ | 4 | 12000 |
| F-5 | CH₃ | 4 | 28000 |
| F-6 | H | 6 | 8000 |
| F-7 | H | 6 | 14000 |
| F-8 | H | 6 | 29000 |
| F-9 | CH₃ | 6 | 10000 |
| F-10 | CH₃ | 6 | 21000 |
| F-11 | H | 8 | 4000 |
| F-12 | H | 8 | 16000 |
| F-13 | H | 8 | 31000 |
| F-14 | CH₃ | 8 | 3000 |

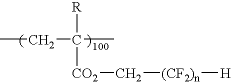

| | R | n | Mw |
|---|---|---|---|
| F-15 | CH₃ | 8 | 10000 |
| F-16 | CH₃ | 8 | 27000 |
| F-17 | H | 10 | 5000 |
| F-18 | H | 10 | 11000 |
| F-19 | CH₃ | 10 | 4500 |
| F-20 | CH₃ | 10 | 12000 |
| F-21 | H | 12 | 5000 |
| F-22 | H | 12 | 10000 |
| F-23 | CH₃ | 12 | 5500 |
| F-24 | CH₃ | 12 | 12000 |

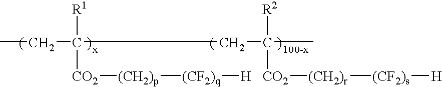

| | x | R¹ | p | q | R² | r | s | Mw |
|---|---|---|---|---|---|---|---|---|
| F-25 | 50 | H | 1 | 4 | CH₃ | 1 | 4 | 10000 |
| F-26 | 40 | H | 1 | 4 | H | 1 | 6 | 14000 |
| F-27 | 60 | H | 1 | 4 | CH₃ | 1 | 6 | 21000 |
| F-28 | 10 | H | 1 | 4 | H | 1 | 8 | 11000 |
| F-29 | 40 | H | 1 | 4 | H | 1 | 8 | 16000 |
| F-30 | 20 | H | 1 | 4 | CH₃ | 1 | 8 | 8000 |
| F-31 | 10 | CH₃ | 1 | 4 | CH₃ | 1 | 8 | 7000 |
| F-32 | 50 | H | 1 | 6 | CH₃ | 1 | 6 | 12000 |
| F-33 | 50 | H | 1 | 6 | CH₃ | 1 | 6 | 22000 |
| F-34 | 30 | H | 1 | 6 | CH₃ | 1 | 6 | 5000 |

The surface state-improving agent of the invention is preferably used in a coating composition containing a ketone series solvent (e.g., acetone, methyl ethyl ketone, methyl isobutyl ketone or cyclohexanone), an ester series solvent (e.g., ethyl acetate or butyl acetate), an ether (tetrahydrofuran or 1,4-dioxane) or an aromatic hydrocarbon series solvent (e.g., toluene or xylene). Of the ketone solvents, methyl ethyl ketone, methyl isobutyl ketone and cyclohexanone are preferred.

The solvent for the coating composition may contain other solvent than the ketone series solvent.

The coating composition preferably contains the ketone series solvent in a content of 10% by mass or more, more preferably 30% by mass or more, still more preferably 60% by mass or more, based on the mass of the whole solvents.

Among the coating compositions for forming layers on the transparent support, coating compositions for forming the hard coat layer, the anti-glare layer, the antistatic layer, the high refractive index layer and the low refractive index layer are particularly preferred as coating compositions to which the surface state-improving agent is added, with coating solutions for forming the hard coat layer and the anti-glare layer being particularly preferred.

(Physical Performance of the Optical Film)

In order to improve physical strength (e.g., scratching resistance) of the optical film in accordance with the invention, the kinetic friction coefficient of the surface thereof on the side having the outermost layer formed by coating is preferably 0.25 or less. The term “kinetic friction coefficient” as used herein means a kinetic friction coefficient between the surface on the side having the outermost layer and a stainless steel-made ball of 5 mm in diameter measured by moving the ball along the surface of the film at a speed of 60 cm/min while applying the ball a load of 0.98 N. The surface kinetic friction coefficient is preferably 0.17 or less, particularly preferably 0.15 or less.

Also, in order to improve stain-proof performance of the optical film, the contact angle of the surface on the side having the outermost layer for water is preferably 80° or more, more preferably 90° or more, particularly preferably 100° or more.

Further, the haze of the anti-reflection film in accordance with the invention is preferably from 0.5 to 60%, more preferably from 1 to 50%, most preferably from 1 to 40%.

Regarding reflectance of the optically functional film in accordance with the invention, a lower reflectance is more preferred. Thus, the reflectance of the film is preferably 3.0% or less, more preferably 2.5% or less, further more preferably 2.0% or less, and particularly preferably 1.5% or less.

(Protective Film for Polarizing Plate)

The optical film of the invention can be used as a protective film for a polarizing film (protective film for a polarizing plate). In this case, the contact angle of the surface of a transparent support on the opposite side to the side having the outermost layer, i.e., the surface on the side to be laminated with the polarizing film, for water is preferably 40° or less, more preferably 30° or less, particularly preferably 25° or less. To render the contact angle to 40° or less is effective for improving adhesion to a polarizing film containing polyvinyl alcohol as a major component. This contact angle can be adjusted by selecting treating conditions of the following saponification treatment.

As a support for an anti-reflection film to be used as a protective film for a polarizing plate, triacetyl cellulose is particularly preferred.

As a method for preparing the protective film of the invention for a polarizing plate, there are illustrated the following two methods:
(1) a method of providing, by coating, the above-described individual layers (e.g., an anti-static layer, a hard coat layer and optically functional layers such as an anti-glare layer, a low refractive index layer, a high refractive index layer and the outermost layer) on one side of a saponification-treated transparent support; and
(2) a method of providing, by coating, the above-described individual layers (e.g., an anti-static layer, a hard coat layer, an anti-glare layer, a low refractive index layer, and the outermost layer) on one side of a transparent support and subjecting the other side to be stuck to a polarizing film to a saponification treatment.

In the method (1), when only one side of the transparent support has been subjected to the saponification treatment, the layers are provided on the side not having been subjected to saponification treatment by coating. In the case where both sides of the transparent support has been subjected to saponification treatment, it is preferred to surface-treat the surface of the saponification-treated transparent support on the side to be coated with the layers by corona discharge treatment, glow discharge treatment or flame treatment, and then to provide the layers by coating.

In the method (2), it is preferred to dip the whole optical film into a saponifying solution. In this case, it is also possible to dip the optical film in the saponifying solution with protecting the surface on the side having individual layers by a protective film to thereby subjecting the surface of the transparent support on the side to be stuck to a polarizing film to the saponification treatment.

Further, it is possible to coat a saponification-treating solution on the surface of the transparent support on the side to be stuck to a polarizing film of an optical film to thereby subject the side to be stuck to the polarizing film to the saponification treatment.

The production cost can be more reduced by performing the saponification treatment after imparting anti-reflection properties to the protective film. In particular, the method (2) is preferred in that it enables one to produce a protective film for a polarizing plate inexpensively.

The protective film for a polarizing plate preferably satisfies the performance described with respect to the optical film of the invention as to optical performance (e.g., low reflecting ability and anti-glare properties), physical properties (e.g., scratching resistance), chemical resistance, stain-proof properties (e.g., stain-resistant properties), weatherabiity (e.g., resistance to moist heat and resistance to light) and dust-proof properties.

Therefore, the surface resistance value of the surface on the side having the outermost layer is preferably 1×10¹³ Ω/□ or less, more preferably 1×10¹² Ω/□, still more preferably 1×10¹⁰ Ω/□.

The kinetic friction coefficient of the surface on the side having the outermost layer is preferably 0.25 or less, more preferably 0.17 or less, particularly preferably 0.15 or less.

Also, the contact angle of the surface on the side having the outermost layer is preferably 90° or more, more preferably 95° or more, particularly preferably 100° or more.

(Saponification Treatment)

The saponification treatment is preferably conducted in a known manner by, for example, dipping the transparent support or the optical film into an alkali solution for an adequate period of time.

The alkali solution is preferably a potassium hydroxide aqueous solution and/or a sodium hydroxide aqueous solution. The concentration is preferably from 0.5 to 3 mol/l, particularly preferably from 1 to 2 mol/l. The solution temperature is preferably from 30 to 70° C., particularly preferably from 40 to 60° C.

After dipping the film into the alkali solution, the film is preferably washed well with water or dipped in a dilute acid to neutralize the alkali component.

The surface of the transparent support is rendered hydrophilic by the saponification treatment. The protective film for a poloarizing plate is used by adhering the hydrophilized surface of the transparent support to the polarizing film.

The hydrophilized surface is effective for improving adhesion properties to a polarizing film containing polyvinyl alcohol as a major component.

The saponification treatment is conducted so that the contact angle of the surface of the transparent support on the side opposite to the side having the anti-glare layer and the low refractive index layer for water becomes preferably 40° or less, more preferably 30° or less, particularly preferably 25° or less.

(Polarizing Plate)

The polarizing plate of the invention has the optical film of the invention on at least one side of a protective film for a polarizing film (protective film for a polarizing plate). As is described above, the contact angle of the surface of the transparent support on the side opposite to the side having the outermost layer, i.e., on the side to be stuck to a polarizing film for water becomes preferably 40° or less.

A polarizing plate having anti-reflection properties can be produced by using the optical film of the invention as a protective film for the polarizing plate, which serves to greatly reduce the production cost and reduce the thickness of a display device.

Also, a polarizing plate wherein the optical film of the invention is used as one of two protective films and an optically anisotropic optically-compensatory film to be described hereinafter is used as the other protective film can improve contrast of a liquid crystal display device in a bright room and markedly enlarge the viewing angle in a vertical direction and in a horizontal direction, thus being preferred.

Optically-compensatory Film

The optically-compensatory film (retardation film) can improve viewing property of a screen of a liquid crystal display device.

As the optically-compensatory film, known ones may be used but, in view of enlarging the viewing angle, an optically-compensatory film described in JP-A-2001-100042, which has an optically anisotropic layer comprising a compound having a discotic structural unit, with the angle between the discotic compound and the film plane vairing in the depth direction of the optically anisotropic film, is preferred. That is, as the alignment state of the compound having the discotic structural unit, hybrid alignment, bend alignment, twist alignment, homogeneous alignment, homeotropic alignment, etc. are preferred, with hybrid alignment being particularly preferred. The angle preferably increases as a whole in the optically anisotropic layer when viewed as an entire layer with an increase in the distance from the support side surface of the optically-compensatory film.

In the case of using the optically-compensatory film as a protective film for a polarizing film, the surface thereof to be stuck to the polarizing film has preferably been subjected to the saponification treatment. The saponification treatment is preferably performed according to the aforesaid saponification treatment.

Further, an embodiment wherein the optically anisotropic layer further contains cellulose ester, an embodiment wherein an orientating layer is formed between the optically anisotropic layer and the optically-compensatory film, an embodiment wherein a transparent support of the optically-compensatory film having the optically anisotropic layer has an optically negative mono-axial properties and has a light axis in the normal direction with respect to the transparent support plane, and an embodiment satisfying the following conditions are preferred as well.
20≦{(nx+ny)/2−nz}×d≦400

In the above formula, nx represents a refractive index in the slow axis direction within the film (maximum in-plane refractive index), ny represents a refractive index in the vertical direction to the slow axis within the film, nz represents a refractive index in the direction vertical to the plane, and d represents a thickness (nm) of the optically anisotropic layer.

Image Display Device

The optically functional film can be applied to an image display device such as a liquid crystal display device (LCD), a plasma display device (PDP), an electroluminescence display (ELD) and a cathode ray tube display device (CRT). The transparent support side of the anti-reflection film is adhered to an image display surface.

The optical film and the polarizing plate to be used in the invention can preferably be used in a transmission type, reflection type or semi-reflection type liquid crystal display device of twisted nematic (TN) mode, super-twisted nematic (STN) mode, vertical alignment (VA) mode, in-plane switching (IPS) mode or optically compensated bend cell (OCB) mode. Particularly, with a liquid crystal display device of TN mode or IPS mode, use of a polarizing plate having the optically-compensatory film and the optical film as protective films as described in JP-A-2001-100043 serves to greatly improve viewing angle characteristics and anti-reflection characteristics.

Also, a transmission type or semi-transmission type display device having a higher viewability can be obtained by using the optically functional film in combination with a commercially available luminance-improving film (a polarization separation film having a polarization-selecting layer; e.g., D-BEF manufactured by Sumitomo 3M K. K.).

Also, the optically functional film can be used in combination with a quarter wave plate to use them as a protective plate for a polarizing plate in a reflection type liquid crystal or in an organic EL display to thereby reduce reflected light from the surface and the interior thereof.

### EXAMPLES

The invention will be described in detail below by reference to Examples which, however, do not limit the invention in any way.

(Synthesis of High Molecular Compound K-1)

0.6 g of polyvinyl alcohol was dissolved in 300 ml of water, and a mixed solution of 81.6 g of methyl methacrylate and 15.9 g of methyl acrylate containing dissolved therein 2 g of azobisisobutyronitrile was added thereto. The resulting mixed solution was stirred for 5 minutes using a Disper, and then weakly stirred at 75° C. in an atmosphere of nitrogen for 4 hours to react.

After completion of the reaction, the reaction solution was weakly dehydrated in a centrifuge, and the product was washed with water and dried to obtain high molecular compound K-1.
(Synthesis of Perfluoroolefin Copolymer PF-1)

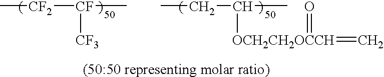

40 Parts by mass of ethylo acetate, 14.7 parts by mass of hydroxyethyl vinyl ether and 0.55 part by mass of dilauroyl peroxide were charged in a stainless steel-made autoclave equipped with a stirrer, and the atmosphere within the autoclave was deaerated and replaced by a nitrogen gas. Further, 25 parts by mass of hexafluoropropylene (HFP) was introduced into the autoclave, followed by raising the temperature to 65° C. The pressure when the temperature within the autoclave reached 65° C. was 5.4 kg/cm² (529 kPa). The reaction was continued for 8 hors while keeping the temperature at the level and, when the pressure reached 3.2 kg/cm² (314 kPa), heating was discontinued, and the reaction solution was allowed to cool. When the inside temperature decreased to room temperature, unreacted monomers were removed, and the autoclave was opened to take out the reaction solution.

The thus-obtained reaction solution was added to a large excess amount of hexane, followed by decantation to remove the solvent. The polymer thus precipitated was taken out. This polymer was then dissolved in a small amount of ethyl acetate and re-precipitated twice from hexane to thereby completely remove residual monomers. Drying of the product gave 28 parts by mass of a polymer product.

Next, 20 parts by mass of the polymer product was dissolved in 100 parts by mass of N,N-dimethylacetamide and, after dropwise adding thereto 11.4 parts by mass of acrylic acid chloride under cooling with ice, the resulting mixture was stirred at room temperature for 10 hours. Ethyl acetate was added to the reacting solution, followed by washing with water. The organic layer was extracted and concentrated. The thus-obtained polymer was re-precipitated from hexane to obtain 19 parts by mass of the perfluoroolefin copolymer PF-1. The refractive index of the resulting perfluoroolefin copolymer was found to be 1.42.

The perfluoroolefin copolymer PF-I was dissolved in methyol ethyl ketone to obtain a solution containing 30% of solid components.

(Preparation of a Solution of Organosilane Compound A)

187 g (0.80 mol) of acryloxypropyltrimethoxysilane, 29.0 g (0.21 mol) of methyltrimethoxysilane, 320 g (10 mols) of methanol and 0.06 g (0.001 mol) of KF were charged in a 1,000-ml reactor equipped with a thermometer, a nitrogen-introducing pipe and a dropping funnel, and 17.0 g (0.94 mol) of water was gradually dropwise added thereto at room temperature under stirring. After completion of the dropwise addition, the mixture was stirred for 3 hours at room temperature, then heated under reflux of methanol for 2 hours while stirring. Subsequently, low-boiling components were distilled off under reduced pressure, followed by filtering the residue to obtain 120 g of a solution of the organosilane compound A. GPC measurement of the thus-obtained substance revealed that the mass-average molecular mass of the compound was 1,500, and the content of components having a molecular mass of from 1,000 to 20,000 was 30% based on the oligomer components and components having a larger molecular mass than the oligomer components.

Also, results of measurement of 1H-NMR revealed that the structure of the resulting substance was a structure represented by the following formula.
Average compositional formula: (CH₂═COO—C₃H₆)_{0.8}(CH₃)_{0.2}SiO_{0.86}(OCH₃)_{1.28}

Further, measurement of 29Si-NMR revealed that condensation ratio α was 0.59. This analytical result shows that the silane coupling agent sol mostly had a straight chain structure moiety.

Also, analysis by gas chromatography revealed that the residual ratio of starting acryloxypropyltrimethoxysilane was 5% or less.

120 Parts by mass of methyl ethyl ketone, 100 parts by mass of 3-acryloxypropyltrimethoxysilane (KBM-5103; manufactured by Shin-Etsu Chemical Co., Ltd.) and 3 parts by mass of diisopropoxyaluminum ethyl acetoacetate were added to a reactor equipped with a stirrer and a reflux condenser and, after mixing, 30 parts by mass of ion-exchanged water was added thereto, followed by reacting at 60° C. for 4 hours. The reaction solution was cooled to room temperature to obtain a solution of the organosilane compound A. This compound had a mass-average molecular mass of 1600, and the content of components having a molecular mass of from 1,000 to 20,000 was 100% based on the oligomer components and components having a larger molecular mass than the oligomer components. Also, analysis by gas chromatography revealed that almost no starting 3-acryloxypropyltrimethoxysilane remained.

(Preparation of Resin Particles (J-1))

600 Parts by mass of water was charged in a reactor equipped with a stirrer and a reflux condenser, and 0.7 part by mass of polyvinyl alcohol and 2.7 parts by mass of sodium dodecylbenzenesulfonate were added thereto and dissolved. Subsequently, a mixed solution of 96.0 parts by mass of methyl methacrylate, 8.0 parts by mass of ethylene glycol dimethacrylate and 2.0 parts by mass of benzoyl peroxide was added thereto and stirred. The resulting mixed solution was dispersed for 15 minutes at 4,000 rpm using a homogenizer to homogenize. Subsequently, stirring was continued for 4 hours at 75° C. while blowing a nitrogen gas thereinto. Thereafter, the reaction solution was lightly dehydrated by centrifugation, and the product was washed with water, and then dried. The thus-obtained cross-linked methyl methacrylate series resin particles (J-1) had an average particle size of 8 μm and a refractive index of 1.50.

Cross-linked resin particles of the invention and resin particles of comparative examples were prepared in the same manner as with the resin particles J-1 except for changing the kind and the amount (unit: parts by mass) of the main monomer of binder and the kind and the amount of cross-linkable monomer. The particle size of particles was adjusted by changing the rotation number of the homogenizer.

Kinds and amounts of the monomers and characteristic values of the prepared particles are shown in Tables 1 and 2.

In Tables 1 and 2, swelling ratio shows a swelling ratio obtained by preparing a 30% dispersion of the particles in toluene and measuring at a point when particle size changes no more with time. The formula for calculation is as described in this specification hereinbefore.

Compressive strength was determined from the test at 10% displacement according to the formula described above, said test is conducted with a single particle at 25° C. and 65%RH under the conditions of FLAT20 in a pressing element for test, 19.6 (mN) in testing load, 0.710982 (mN/sec) in load speed and 5 (μn stroke value by using a micro compression testing machine MCT-W201 manufactured by Shimadzu Mfg. Works.

TABLE 1

| | J-1 | J-2 | J-3 | J-4 | J-5 | J-6 | J-7 | J-8 | J-9 | J-10 | J-11 | J-12 |
|---|---|---|---|---|---|---|---|---|---|---|---|---|
| Methyl methacrylate | 96 | 90 | 80 | 80 | 80 | 80 | — | — | — | 96 | 92 | 86 |
| Styrene | — | — | — | — | — | — | 100 | 90 | 92 | — | — | — |
| Divinyl-benzene | — | — | — | — | — | — | 11 | 25 | — | 11 | 22 | 40 |
| Divinyl-naphthalene | — | — | — | — | — | — | — | — | 25 | — | — | — |
| Ethylene glycol | 8 | 20 | 40 | 40 | 40 | 40 | — | — | — | — | — | — |
| di-methacrylate | | | | | | | | | | | | |
| Pentaeryth-ritol | — | — | — | — | — | — | — | — | — | — | — | — |
| tetra-acrylate | | | | | | | | | | | | |
| Ethyl acrylate | — | — | — | — | — | — | — | — | — | — | — | — |
| Butyl acrylate | — | — | — | — | — | — | — | — | — | — | — | — |
| Hexanediol diacrylate | — | — | — | — | — | — | — | — | — | — | — | — |
| Average particle size (μm) | 8 | 8 | 5 | 8 | 14 | 20 | 8 | 8 | 8 | 8 | 8 | 8 |
| Refractive index | 1.50 | 1.50 | 1.50 | 1.50 | 1.50 | 1.50 | 1.60 | 1.60 | 1.60 | 1.51 | 1.52 | 1.54 |
| Compressive strength | 4.2 | 5.2 | 6.2 | 6.2 | 6.2 | 6.2 | 2.3 | 2.8 | 3.6 | 4.7 | 6.1 | 7.0 |
| (kgf/mm²) | | | | | | | | | | | | |
| Swelling ratio (volume %) | 26 | 18 | 12 | 11 | 11 | 11 | 25 | 17 | 12 | 21 | 14 | 10 |
| Content of cross- | 8 | 18 | 33 | 33 | 33 | 33 | 10 | 22 | 21 | 10 | 19 | 32 |
| linkable monomer (mass %) | | | | | | | | | | | | |

TABLE 2

| | J-13 | J-14 | J-15 | J-16 | J-17 | J-18 | J-19* | J-20* | J-21* | J-22* | J-23* |
|---|---|---|---|---|---|---|---|---|---|---|---|
| Methyl methacrylate | 86 | 89 | 82 | 82 | 82 | 50 | — | — | — | 80 | 80 |
| Styrene | — | — | — | — | — | 50 | — | — | — | — | — |
| Divinyl-benzene | 40 | — | — | — | — | 20 | — | — | — | — | — |
| Divinyl-naphthalene | — | — | — | — | — | — | — | — | — | — | — |
| Ethylene glycol | — | — | — | — | — | — | — | — | — | 40 | 40 |
| di-methacrylate | | | | | | | | | | | |
| Pentaeryth-ritol | — | 25 | 50 | 50 | 50 | — | — | — | — | — | — |
| tetra-acrylate | | | | | | | | | | | |
| Ethyl acrylate | — | — | — | — | — | — | 96 | 96 | — | — | — |
| Butyl acrylate | — | — | — | — | — | — | — | — | 123 | — | — |
| Hexanediol diacrylate | — | — | — | — | — | — | 4 | 4 | 4 | — | — |
| Average particle size (μm) | 20 | 8 | 5 | 8 | 20 | 8 | 8 | 20 | 8 | 3 | 24 |
| Refractive index | 1.54 | 1.51 | 1.51 | 1.51 | 1.51 | 1.55 | 1.51 | 1.51 | 1.51 | 1.50 | 1.50 |
| Compressive strength | 7.0 | 6.2 | 7.8 | 7.8 | 7.8 | 4.0 | 0.9 | 0.9 | 1.1 | 6.2 | 6.2 |
| (kgf/mm²) | | | | | | | | | | | |
| Swelling ratio (volume %) | 10 | 12 | 7 | 7 | 7 | 18 | 36 | 37 | 32 | 11 | 11 |
| Content of cross- | 32 | 22 | 38 | 38 | 38 | 17 | 4 | 4 | 3 | 33 | 33 |
| linkable monomer (mass %) | | | | | | | | | | | |

*(for comparison)

(Preparation of a Coating Solution H-1 for Forming a Light-Diffusing Layer)

To 45.0 parts by mass of a mixture (KAYARAD PET-30; manufactured by Nippon Kayaku) of pentaerythritol triacrylate and pentaerythritol tetraacrylate were added 2.0 parts by mass of a polymerization initiator (Irgacure 184; manufactured by Ciba Specialty Chemicals), 0.75 part by mass of the fluorine-containing surface state-improving agent (F-12), 10.0 parts by mass of KBM-5103; manufactured by Shin-Etsu Chemical Co., Ltd.), 8.5 parts by mass of a 20% by mass solution of polymethyl methacrylate in toluene (mass-average molecular mass: 120,000; manufactured by Sigma-Aldrich Japan K.K.) and 28.5 parts by mass of toluene. A coated film obtained by coating this solution and UV-curing it had a refractive index of 1.51.

Further, to this solution was added 25.5 parts by mass of a 30% dispersion of resin particles J-1 in toluene having been dispersed in a polytron dispersing machine at 10,000 rpm, followed by stirring the resulting mixture. The mixture was then filtered through a polypropylene-made filter of 30 μm in pore size to prepare a coating solution H-1 for forming a light-diffusing layer.

(Preparation of Coating Solutions H-2 to H-20, RH-1 (for comparison) to RH-5 (for comparison) for Forming a Light-diffusing Layer)

Coating solutions H-2 to H-18, RH-1 (for comparison) to RH-5 (for comparison) for forming a light-diffusing layer were prepared in the same manner as with the coating solution H-1 except for changing resin particles J-1 to J-2 to J-23, respectively. Further, coating solutions H-19 to H-20 for forming a light-diffusing layer were prepared by replacing the binder component and the photo polymerization initiator in equal parts by mass.

Combinations of individual coating solution formulations are as shown in Table 3.

TABLE 3

| | | | | Photo |
|---|---|---|---|---|
| | | Resin | | polymerization |
| Coating solution No. | | particles | Binder component | initiator |
| H-1 | Present | J-1 | KAYARAD PET-30 | Irgacure 184 |
| | invention | | | |
| H-2 | Present | J-2 | KAYARAD PET-30 | Irgacure 184 |
| | invention | | | |
| H-3 | Present | J-3 | KAYARAD PET-30 | Irgacure 184 |
| | invention | | | |
| H-4 | Present | J-4 | KAYARAD PET-30 | Irgacure 184 |
| | invention | | | |
| H-5 | Present | J-5 | KAYARAD PET-30 | Irgacure 184 |
| | invention | | | |
| H-6 | Present | J-6 | KAYARAD PET-30 | Irgacure 184 |
| | invention | | | |
| H-7 | Present | J-7 | KAYARAD PET-30 | Irgacure 184 |
| | invention | | | |
| H-8 | Present | J-8 | KAYARAD PET-30 | Irgacure 184 |
| | invention | | | |
| H-9 | Present | J-9 | KAYARAD PET-30 | Irgacure 184 |
| | invention | | | |
| H-10 | Present | J-10 | KAYARAD PET-30 | Irgacure 184 |
| | invention | | | |
| H-11 | Present | J-11 | KAYARAD PET-30 | Irgacure 184 |
| | invention | | | |
| H-12 | Present | J-12 | KAYARAD PET-30 | Irgacure 184 |
| | invention | | | |
| H-13 | Present | J-13 | KAYARAD PET-30 | Irgacure 184 |
| | invention | | | |
| H-14 | Present | J-14 | KAYARAD PET-30 | Irgacure 184 |
| | invention | | | |
| H-15 | Present | J-15 | KAYARAD PET-30 | Irgacure 184 |
| | invention | | | |
| H-16 | Present | J-16 | KAYARAD PET-30 | Irgacure 184 |
| | invention | | | |
| H-17 | Present | J-17 | KAYARAD PET-30 | Irgacure 184 |
| | invention | | | |
| H-18 | Present | J-18 | KAYARAD PET-30 | Irgacure 184 |
| | invention | | | |
| H-19 | Present | J-4 | HP-7200 | UVI-6990 |
| | invention | | | |
| H-20 | Present | J-4 | GT-401 | UVI-6990 |
| | invention | | | |
| RH-1 | Comparative | J-19 | KAYARAD PET-30 | Irgacure 184 |
| | example | | | |
| RH-2 | Comparative | J-20 | KAYARAD PET-30 | Irgacure 184 |
| | example | | | |
| RH-3 | Comparative | J-21 | KAYARAD PET-30 | Irgacure 184 |
| | example | | | |
| RH-4 | Comparative | J-22 | KAYARAD PET-30 | Irgacure 184 |
| | example | | | |
| RH-5 | Comparative | J-23 | KAYARAD PET-30 | Irgacure 184 |
| | example | | | |

HP-7200: dicyclopentadiene type epoxy resin (manufactured by Dainippon Ink & Chemicals, Inc.)
GT-401: EPOLEAD GT-401; 4-functional epoxy compound (manufactured by Daicel Chemical Ind.)
UVI-6990: cationic polymerization initiator (manufacture4d by Ciba Specialty Chemicals)

(Preparation of a Coating Solution L-1 for Forming a Low Refractive Index Layer)

To 15.0 parts by mass of a thermally cross-linkable fluorine-containing polymer of 1.42 in refractive index (JN7228A; solids concentration: 6%; manufactured by JSR) were added 0.6 part by mass of a dispersion of silica fine particles in MKE (MEK-ST; average particle size: 15 nm; solids concentration: 30%; manufactured by Nissan Chemical Industries, Ltd.), 0.8 part by mass of a dispersion of silica fine particles in MEK (MEK-ST-L; average particle size: 45 nm; solids concentration: 30%; manufactured by Nissan Chemical Industries, Ltd.), 0.4 part by mass of the organosilane compound A solution, 3.0 parts by mass of methyl ethyl ketone and 0.6 part by mass of cyclohexanone, followed by stirring the resulting mixture. The mixture was filtered through a polypropylene-made filter of 1 μm in pore size to prepare a coating solution L-1 for forming a low refractive index layer. The coated film formed from this coating solution had a refractive index of 1.42.

(Preparation of a Dispersion of Hollow Silica Fine Particles in MEK)

To 500 parts by mass of a sol of hollow silica fine particles (isopropyl alcohol silica sol; manufactured by Catalysts & Chemicals Industries Co., Ltd.; average particle size: 60 nm; shell thickness: 10 nm; silica concentration: 20%; refractive index of silica particles: 1.31; prepared according to Preparation Example 4 in JP-A-2002-79616 by changing the size) were added 30 parts by mass of acryloyloxypropyltrimethoxysilane (manufactured by Shin-Etsu Chemical Co., Ltd.) and 1.5 parts by mass of diisopropoxyaluminum ethyl acetate (trade name: Chelope EP-12; manufactured by Hope Chemical Co., Ltd.), followed by adding thereto 9 parts by mass of ion-exchanged water. After reacting for 8 hours at 60° C., the reaction solution was cooled to room temperature, and 1.8 parts by mass of acetylacetone was added thereto. Solvent replacement was conducted by distillation under reduced pressure at a pressure of 20 kPa while adding methyl ethyl ketone to 500 g of the dispersion with keeping the content of silica at about a constant level. No undesired products were generated, and the viscosity of the dispersion when the solids concentration was adjusted to 20% by mass with methyl ethyl ketone was found to be 5 mPa·s at 25° C. The residual amount of isopropyl alcohol in the thus-obtained dispersion A-1 was analyzed by gas chromatography and was found to be 1.5%.

(Preparation of a Coating Solution L-2 for Forming a Low Refractive Index Layer)

To 13.0 parts by mass of a thermally cross-linkable fluorine-containing polymer of 1.42 in refractive index (JN7228A; solids concentration: 6%; manufactured by JSR) were added 1.95 parts by mass of a dispersion of the hollow silica fine particles in MKE (refractive index: 1.31; average particle size: 60 nm; solids concentration: 20%), 0.6 part by mass of the organosilane compound A solution, 4.35 parts by mass of methyl ethyl ketone and 0.6 part by mass of cyclohexanone, followed by stirring the resulting mixture. The mixture was filtered through a polypropylene-made filter of 1 μm in pore size to prepare a coating solution L-2 for forming a low refractive index layer. The coated film formed from this coating solution had a refractive index of 1.40.

To 10.5 parts by mass of the perfluoroolefin copolymer PF-1 (solids concentration: 30%) were added 4.5 parts by mass of a dispersion of silica fine particles in MKE (MEK-ST-L; average particle size: 45 nm; solids concentration: 30%; manufactured by Nissan Chemical Industries, Ltd.), 0.15 part by mass of a polysiloxane compound having an acryloyl group (X-22-164C; manufactured by Shin-Etsu Chemical Co., Ltd.), 0.23 part by mass of a photo polymerization initiator (Irgacure 907; manufactured by Ciba Specialty Chemicals), 2.0 parts by mass of the organosilane compound A solution, 81.2 parts by mass of methyl ethyl ketone and 2.8 parts by mass of cyclohexanone, followed by stirring the resulting mixture. The mixture was filtered through a polypropylene-made filter of 1 μm in pore size to prepare a coating solution L-3 for forming a low refractive index layer. The coated film formed from this coating solution had a refractive index of 1.44.

### EXAMPLE 1

Each of the coating solutions (H-1 to H-20) for forming a light-diffusing layer and coating solutions (RH-1 to RH-5) for comparison was coated on a triacetyl cellulose film of 80 μm in thickness and 1340 mm in width (TAC-TD80; manufactured by Fuji Photo Film Co., Ltd.; refractive index: 1.48) according to the slot die method at a conveying speed of 25 m/min with adjusting the thickness by controlling the coating amount.

After drying at 60° C. for 150 seconds, the coated layer was cured by irradiating with UV rays with an iluminance of 400 mW/cm² and an irradiation amount of 250 mJ/cm² using a 160 W/cm air-cooled metal halide lamp (EYEGRAPHICS Co., Ltd.) while purging with nitrogen (oxygen concentration: 0.5% or less), thus a film sample having a light-diffusing layer being obtained.

Each of the coating solutions (L-1 to L-3) for forming a low refractive index layer was coated on the light-diffusing layer according to the slot die coating method at a conveying speed of 25 m/min with adjusting the thickness to 100 nm.

Thereafter, drying and curing of L-1 to L-2 were conducted under the following conditions.

After drying at 120° C. for 150 seconds, then further at 140° C. for 8 minutes, the coated layer was cured by irradiating with UV rays with an iluminance of 400 mW/cm² and an irradiation amount of 900 mJ/cm² using a 240 W/cm air-cooled metal halide lamp (EYEGRAPHICS Co., Ltd.) while purging with nitrogen (oxygen concentration: 0.5% or less), thus a low refractive index layer (outermost layer) being formed.

Also, drying and curing of L-3 were conducted under the following conditions.

After drying at 90° C. for 30 seconds, the coated layer was cured by irradiating with UV rays with an iluminance of 600 mW/cm² and an irradiation amount of 900 mJ/cm2 using a 600 W/cm air-cooled metal halide lamp (EYEGRAPHICS Co., Ltd.) while purging with nitrogen (oxygen concentration: 0.5% or less), thus a low refractive index layer (outermost layer) being formed.

Coating combinations and thickness values of the light-diffusing layer and the low refractive index layer of optical film samples in accordance with the invention were as described in Table 4.

TABLE 4

| | | Coating | | |
|---|---|---|---|---|
| | | solution for | | Coating |
| | | forming | Thickness of | solution for |
| | | light- | light- | forming low |
| | | diffusing | diffusing | refractive |
| Sample No. | | layer | layer (μm) | index layer |
| 101 | Present invention | H-1 | 18 | L-1 |
| 102 | Present invention | H-2 | 18 | L-1 |
| 103 | Present invention | H-3 | 18 | L-1 |
| 104 | Present invention | H-4 | 18 | L-1 |
| 105 | Present invention | H-5 | 18 | L-1 |
| 106 | Present invention | H-6 | 18 | L-1 |
| 107 | Present invention | H-6 | 12 | L-1 |
| 108 | Present invention | H-6 | 26 | L-1 |
| 109 | Present invention | H-7 | 18 | L-1 |
| 110 | Present invention | H-8 | 18 | L-1 |
| 111 | Present invention | H-9 | 18 | L-1 |
| 112 | Present invention | H-10 | 18 | L-1 |
| 113 | Present invention | H-11 | 18 | L-1 |
| 114 | Present invention | H-12 | 18 | L-1 |
| 115 | Present invention | H-13 | 18 | L-1 |
| 116 | Present invention | H-14 | 18 | L-1 |
| 117 | Present invention | H-15 | 18 | L-1 |
| 118 | Present invention | H-16 | 18 | L-1 |
| 119 | Present invention | H-17 | 18 | L-1 |
| 120 | Present invention | H-18 | 18 | L-1 |
| 121 | Present invention | H-19 | 18 | L-1 |
| 122 | Present invention | H-20 | 18 | L-1 |
| 123 | Present invention | H-4 | 18 | L-2 |
| 124 | Present invention | H-4 | 18 | L-3 |
| 125 | Present invention | H-8 | 18 | L-2 |
| 126 | Present invention | H-8 | 18 | L-3 |
| 127 | Comparative example | RH-1 | 18 | L-1 |
| 128 | Comparative example | RH-2 | 18 | L-1 |
| 129 | Comparative example | RH-3 | 18 | L-1 |
| 130 | Comparative example | RH-4 | 18 | L-1 |
| 131 | Comparative example | RH-5 | 18 | L-1 |
| 132 | Present invention | H-4 | 18 | none |
| 133 | Present invention | H-8 | 18 | none |
| 134 | Present invention | H-11 | 18 | none |
| 135 | Present invention | H-16 | 18 | none |
| 136 | Present invention | H-17 | 18 | none |
| 137 | Comparative example | RH-1 | 18 | none |

Thickness: thickness of each coated layer after irradiation with UV or after thermal treatment

(Evaluation of Optical Films)

The thus-obtained optical films were evaluated with respect to the following items. Results are shown in Table 5.

(1) Anti-Glare Properties

The whole surface of each of the prepared optical film samples on the opposite side to the side on which the light-diffusing layer had been coated was painted out with a black oily ink. A bare fluorescent lamp (8000 cd/cm²) with no louver was reflected on the light-diffusing layer-provided side, and the degree of blurring of the reflected image and whiteness of the whole surface were evaluated according to the following standard.
OO: The outline of the fluorescent lamp was scarcely recognized.
O: The outline of the fluorescent lamp was slightly recognized.
Δ: The circumference of the fluorescent lamp appeared whitish, but the outline was recognizable (within permissible degree).
x(1): The fluorescent lamp was clearly recognized, with dazzling reflected light.
x(2): Though the outline of the fluorescent lamp was not recognizable, the whole surface appeared whitish.
   (2) Evaluation of Average Reflectance

The spectral reflectance was measured at an incident angle of 5° in the wavelength region of from 380 to 780 nm using a spectrophotometer (V-550; manufactured by JASCO Corporation) and an integrating sphere. In evaluating the spectral reflectance, an average reflectance of from 450 to 650 nm was used.

(3) Pencil Hardness

The pencil hardness was evaluated with respect to the light-diffusing layer-coated side of each sample according to the description in JIS K 5400. After conditioning the anti-reflection film at a temperature of 25° C. and a humidity of 60% RH for 2 hours, the hardness test was conducted under a load of 500 g using a pencil for the test of 3 H to 8 H specified in JIS S 6006. The test was conducted starting with the softest pencil and, of the results obtained by repeatedly conducting the test under the same condition 5 times, a pencil hardness which was the hardest of the pencil hardness results showing no scratches 3 times or more was taken as the hardness of the sample.

(4) Steel Wool Resistance

A rubbing test with a steel wool using a rubbing tester was conducted with respect to the light-diffusing layer-provided side. As a rubbing member, steel wool (grade No. 0000; manufactured by Japan Steel Wool Corp.) was used, and the test was conducted under the conditions of 13 cm in stroke distance (one way), 13 cm/sec in rubbing speed, 4.9 N/cm² in load, 1 cm×1 cm in contact area and 10 strokes in rubbing stroke number. Scratches formed on the outermost layer were visually observed and evaluated according to the following 4 grades.
OO: No scratches were observed with careful observation.
O: Slight scratches were observed with careful observation.
Δ: Weak scratches were observed.
x: Conspicuous scratches were observed at a glance.
   (5) Curling Degree

Each of the optical film samples was cut out into a size of 20 cm×20 cm, and the cut piece was placed in an environment of 15° C. and 60% RH on a horizontal desk surface with the surface whose four corners were rising from the surface plane facing upward. After 24 hours, the rising distance of each corner from the desk surface was measured by a ruler, and measured distances at 4 corners were averaged. The average value was evaluated by classifying according to the following standard.
OO: less than 5 mm
O: 5 to less than 10 mm
OΔ: 10 to less than 20 mm
Δ: 20 to less than 40 mm

x: 40 or more

TABLE 5

| | | Anti- | | | Steel | |
|---|---|---|---|---|---|---|
| | | glare | Average | Pencil | wool | |
| | | proper- | reflec- | hard- | resis- | Curling |
| Sample No. | | ties | tance | ness | tance | degree |
| 101 | Present | ∘ | 2.5 | 4H | ∘ | ∘ |
| | invention | | | | | |
| 102 | Present | ∘ | 2.5 | 4H | ∘ | ∘ |
| | invention | | | | | |
| 103 | Present | Δ | 2.7 | 4H | Δ | ∘ |
| | invention | | | | | |
| 104 | Present | ∘ | 2.5 | 4H | ∘ | ∘ |
| | invention | | | | | |
| 105 | Present | ∘ | 2.5 | 4H | ∘ | ∘ |
| | invention | | | | | |
| 106 | Present | ∘ | 2.4 | 5H | ∘ | ∘ |
| | invention | | | | | |
| 107 | Present | ∘ | 2.5 | 3H | Δ | ∘∘ |
| | invention | | | | | |
| 108 | Present | ∘∘ | 2.5 | 7H | ∘∘ | Δ |
| | invention | | | | | |
| 109 | Present | ∘∘ | 2.4 | 3H | ∘ | ∘ |
| | invention | | | | | |
| 110 | Present | ∘∘ | 2.5 | 4H | ∘ | ∘ |
| | invention | | | | | |
| 111 | Present | ∘∘ | 2.5 | 4H | ∘ | ∘ |
| | invention | | | | | |
| 112 | Present | ∘ | 2.5 | 4H | ∘ | ∘ |
| | invention | | | | | |
| 113 | Present | ∘ | 2.6 | 6H | ∘ | ∘ |
| | invention | | | | | |
| 114 | Present | ∘∘ | 2.6 | 4H | ∘ | ∘ |
| | invention | | | | | |
| 115 | Present | ∘∘ | 2.5 | 4H | ∘∘ | ∘ |
| | invention | | | | | |
| 116 | Present | ∘ | 2.5 | 4H | ∘ | ∘ |
| | invention | | | | | |
| 117 | Present | Δ | 2.7 | 5H | ∘ | ∘ |
| | invention | | | | | |
| 118 | Present | ∘ | 2.5 | 5H | ∘∘ | ∘ |
| | invention | | | | | |
| 119 | Present | ∘∘ | 2.5 | 6H | ∘∘ | ∘ |
| | invention | | | | | |
| 120 | Present | ∘ | 2.6 | 4H | ∘ | ∘ |
| | invention | | | | | |
| 121 | Present | ∘ | 2.5 | 4H | ∘ | ∘∘ |
| | invention | | | | | |
| 122 | Present | ∘ | 2.5 | 4H | ∘ | ∘∘ |
| | invention | | | | | |
| 123 | Present | ∘ | 1.9 | 4H | ∘ | ∘ |
| | invention | | | | | |
| 124 | Present | ∘ | 2.5 | 4H | ∘ | ∘ |
| | invention | | | | | |
| 125 | Present | ∘ | 2.0 | 4H | ∘ | ∘ |
| | invention | | | | | |
| 126 | Present | ∘ | 2.5 | 4H | ∘ | ∘ |
| | invention | | | | | |
| 127 | Comparative | ∘ | 2.5 | 2H | x | ∘ |
| | example | | | | | |
| 128 | Comparative | ∘ | 2.5 | 2H | x | ∘ |
| | example | | | | | |
| 129 | Comparative | ∘ | 2.5 | 2H | x | ∘ |
| | example | | | | | |
| 130 | Comparative | x(1) | 2.2 | 3H | Δ | ∘ |
| | example | | | | | |
| 131 | Comparative | x(2) | 3.1 | 6H | ∘ | ∘ |
| | example | | | | | |
| 132 | Present | ∘ | 3.5 | 4H | ∘ | ∘ |
| | invention | | | | | |
| 133 | Present | ∘ | 3.6 | 4H | ∘ | ∘ |
| | invention | | | | | |
| 134 | Present | ∘ | 3.5 | 4H | ∘ | ∘ |
| | invention | | | | | |
| 135 | Present | ∘ | 3.4 | 4H | ∘∘ | ∘ |
| | invention | | | | | |
| 136 | Present | ∘ | 3.5 | 4H | ∘∘ | ∘ |
| | invention | | | | | |
| 137 | Comparative | ∘ | 3.5 | 2H | x | ∘ |
| | example | | | | | |

It is seen from the results in Table 5 that, when the particle size of the particles is within the range of from 5 μm to 20 μm, there resulted good anti-glare properties and pencil hardness (samples 101 to 126 and 132 to 136 in comparison with samples 130 and 131). Also, when the compressive strength is 2 kgf/mm² or more, there resulted good pencil hardness (samples 101 to 126 and 132 to 136 in comparison with samples 127 to 129). Further, it is seen that, when the film thickness was increased by using particles having a large compressive strength, there resulted a tendency of the film strength being improved (sample 108).

It has been found for the first time by the invention to enhance film strength by using large particles having a high compressive strength and increasing the thickness of the film thickness using large particles having a high compressive strength.

### EXAMPLE 2

(Evaluation of an Image Display Device)

Each of the optical films of samples 101 to 126 and 132 to 136 in Example 1was mounted on the display surface of an image display device (a transmission type, reflection type or semi-reflection type liquid crystal display device of TN mode, STN mode, IPS mode, VA mode or OCB mode, or a plasma display panel (PDP), an electroluminescence display (ELD) or a cathode ray tube display device (CRT)). The image display device using the optical film of the invention was excellent in anti-reflection properties, surface hardness, scratching resistance and stain-proof properties.

Further, there existed no depressions of 100 μm² or more in cross-sectional area, and dazzling trouble was not generated in an image display device with a pixel size being 100 ppi (100 pixels/inch; 100 pixels existing per inch in length).

### EXAMPLE 3

(Preparation of a Protective Film for a Polarizing Plate)

A saponifying solution of a 1.5 N sodium hydroxide aqueous solution kept at 50° C. was prepared. Further, a 0.01 N dilute sulfuric acid aqueous solution was prepared.

The surface of the transparent support of each of the ant-reflection films of samples 101 to 126 and 132 to 136 in Example 1 on the opposite side to the side having the low refractive index layer (outermost layer) was subjected to saponification treatment using the saponifying solution.

The sodium hydroxide aqueous solution on the saponification-treated transparent support was well washed away with water, followed by washing the support with the dilute sulfuric acid aqueous solution and well drying at 100° C.

The contact angle of the surface of the saponification-treated transparent support of each optical film on the opposite side to the side having the low refractive index layer (outermost layer) for water was evaluated and was found to be 40° or less. Thus, protective films for a polarizing plate were prepared.

(Preparation of a Polarizing Plate)

Each of the anti-reflection films of the invention (protective films for a polarizing plate) was stuck onto one side of a polarizing film described in JP-A-2002-86554 using a 3% aqueous solution of PVA (PVA-117H manufactured by Kuraray) as an adhesive, with the saponification-treated triacetyl cellylose side of the anti-reflection film facing the polarizing film. Further, a triacetyl cellulose film (Fuji TAC; manufactured by Fuji Photo Film Co., Ltd.; retardation value: 3.0 nm) having been subjected to the same saponification treatment as described above was stuck onto the other side of the polarizing film using the same adhesive. Thus, polarizing plates of the invention were prepared.

(Evaluation of an Image Display Device)

A transmission type, reflection type or semi-reflection type liquid crystal display device of TN mode, STN mode, IPS mode, VA mode or OCB mode having mounted thereon the thus-prepared polarizing plate of the invention was excellent in anti-reflection properties, dust-proof properties, scratching resistance and stain-proof properties.

Additionally, the same results were obtained with polarizing plates prepared in the same manner as described above using various known polarizing films.

### EXAMPLE 4

(Preparation of a Polarizing Plate)

The surface of an optically-compensatory film (wide view film SA 12B; manufactured by Fuji Photo Film Co., Ltd.) on the opposite side to the side having an optically anisotropic layer was subjected to the saponification treatment under the same conditions as in Example 3. The saponficication-treated triacetyl cellulose side of the optical film (protective film for a polarizing plate) prepared in Example 3 was stuck onto one side of a polarizing film in the same manner as in Example 3. Further, the triacetyl cellulose surface of the saponification-treated optically-compensatory film was similarly stuck onto the other side of the polarizing film.

A transmission type, reflection type or semi-reflection type liquid crystal display device of TN mode, STN mode, IPS mode, VA mode or OCB mode having mounted thereon the thus-prepared polarizing plate of the invention showed better contrast in a bright room, provided a wider viewing angle in the vertical direction and in the horizontal direction, and was more excellent in anti-reflection properties, surface hardness, scratching resistance and stain-proof properties in comparison with a liquid crystal display device having mounted thereon a polarizing plate not using the optically-compensatory film.

In particular, the viewing angle in the downward direction was markedly enlarged by the light-scattering effect of the resin particles, and yellowish tint in the horizontal direction was improved.

Additionally, the same results were obtained with polarizing plates prepared in the same manner as described above using various known polarizing films.

### EXAMPLE 5

(Evaluation of an Image Display Device)

When the anti-reflection film of each of samples 101 to 126 and 132 to 136 in Example 1 was mounted on an organic EL display device, there were obtained excellent anti-reflection properties, dust-proof properties, scratching resistance and stain-proof properties.

Also, a polarizing plate having on one side the protective film for a polarizing plate prepared in Example 4 on one side of a polarizing film, and having on the other side a quarter wave plate was prepared in the same manner as in Example 5. When the polarizing plate was mounted on an organic EL display device, reflection of light from the glass surface laminated with the polarizing plate was prevented, thus a display device providing an extremely high viewability being obtained.

According to the invention, by the presence of resin particles having a specific compressive strength in the light-diffusing layer, there can be provided an optical film having excellent various optical properties such as anti-reflection properties and having a high surface hardness. Also, since, this optical film is used in an anti-reflection film, a polarizing plate and an image display device, images with a high quality having an excellent viewability can be obtained.

The entire disclosure of each and every foreign patent application from which the benefit of foreign priority has been claimed in the present application is incorporated herein by reference, as if fully set forth.

What is claimed is:

1. An optical film, which comprises:
a transparent support; and
a light-diffusing layer containing: at least one kind of resin particles having a particle size of from 5 μm to 20 μm; and a binder matrix,
wherein the resin particles have a compressive strength of from 2 to 10 kgf/mm².

2. The optical film according to claim 1,
wherein the resin particles show a swelling ratio of 20% by volume or less when dipped in a dispersing solvent.

3. The optical film according to claim 1,
wherein the light-diffusing layer has a thickness of from 10 μm to 20 μm.

4. The optical film according to claim 1,
wherein the resin particles are cross-linked with a cross-linking monomer having two or more functional groups, and
a content of the cross-linking monomer is 15% by mass or more based on a mass of the total monomers for forming the resin particles.

5. The optical film according to claim 1,
wherein a difference in refractive index between the resin particles and the binder matrix is from 0 to 0.10.

6. The optical film according to claim 1,
wherein the resin particles are resin particles obtained by polymerizing a (meth)acrylate monomer.

7. The optical film according to claim 1,
wherein the light-diffusing layer contains as a binder an epoxy resin having two or more epoxy groups per molecule in a content of from 20 to 100% by mass based on a mass of the total binders.

8. An anti-reflection film,
wherein the anti-reflection film is an optical film according to claim 1.

9. A polarizing plate, which comprises:
a polarizing film; and
at least two protective films for the polarizing film, wherein at least one of the at least two protective films is an anti-reflection film according to claim 8.

10. An image display device, which comprises an optical film according to claim 1, an anti-reflection film according to claim 8 or a polarizing plate according to claim 9 disposed on an image display surface.
